(19) United States
(12) Patent Application Publication
(10) Pub. No.: US 2025/0138037 A1
(43) Pub. Date: May 1, 2025

(54) APPARATUS FOR MOVING SAMPLE HOLDERS

(71) Applicant: FEI Company, Hillsboro, OR (US)

(72) Inventors: Martin CAFOUREK, Brno (CZ); Jan PATÁK, Brno (CZ)

(73) Assignee: FEI Company, Hillsboro, OR (US)

(21) Appl. No.: 18/690,613

(22) PCT Filed: Sep. 7, 2022
(86) PCT No.: PCT/EP2022/074852

§ 371 Date: Mar. 8, 2024

(30) Foreign Application Priority Data
Sep. 8, 2021 (GB) 2112766.7

(51) Int. Cl. G01N 35/04; B65G 25/06

(52) U.S. Cl. CPC G01N 35/04; B65G 25/06; G01N 2035/0465

(57) ABSTRACT

An apparatus for moving first and second sample holders between respective first and second starting positions and respective first and second end positions comprises a guide assembly configured to: guide the first sample holder along a first path from the first starting position to the first end position and back along the first path from the first end position to the first starting position; and guide the second sample holder along a second path from the first starting position to the second end position and back along the second path from the second end position to the second starting position. The guide assembly is configured such that the first and second sample holders are spaced apart as they move along at least a portion of the lengths of their respective paths.

### FIELD OF THE DISCLOSURE

The present disclosure concerns apparatus for moving sample holders and analytical instruments incorporating the apparatus described herein.

### BACKGROUND TO THE DISCLOSURE

Many analytical instruments require samples of material to be transferred from one position to another position for analysis or processing of samples. For example, samples may be loaded in sample holders at a starting position and unloaded to an analyser or analysed within their sample holder at an end position or an analysis position. Apparatus for moving sample holders in this way are sometimes described as transfer assemblies or sample conveying systems.

An example of an analytical instrument that uses an apparatus for moving sample holders from one position to another position is the Thermo Scientific™ ARL™ 9900 Spectrometer, which is an X-Ray Fluorescence (XRF) system that permits fast analysis of metallic or non-metallic samples in various industries for process or quality control. FIG. 1 shows a simplified version of the ARL 9900 Spectrometer, which comprises a shutter 170, which serves as an air lock between the atmospheric pressure outside and the vacuum environment of the spectrometer. The spectrometer further comprises a sample lift (sometimes termed an “input lift”) 180, which is a mechanism for transferring a sample holder from a sample changer into a primary chamber of the spectrometer. Moreover, the spectrometer comprises a transfer assembly 110 for moving a sample holder to an analysis lift (sometimes termed an “X-ray lift”) 190, where the sample holder is lifted for subsequent XRF analysis. An X-Ray tube 167 for XRF is provided. Moreover, a sample changer 195 is also provided. In this case, a rotational sample changer is shown, although other types of sample changers are possible (e.g. sample changers with X-Y arms can be used instead). FIG. 2 shows the ARL 9900 in more detail. As can be seen in FIG. 2, the ARL 9900 comprises: a sample conveying system 110; an input lift 180; an X-Ray lift 190; a vacuum boundary 161 showing a region (defined collectively by: the spectrometer tank shown by the right-hand branch of the arrow for reference numeral 161; and the front housing shown by the left-hand branch of the arrow for reference numeral 161) that can be under vacuum; the rectilinear translation 162 of sample holders; a spectrometer tank 163; a sample changer 164; a molecular pump 165; a rotary pump 166; an X-Ray tube 167 for XRF; a gas regulation system 172; an XRD tube 171a; an XRD tube rotation mechanism 171b; an XRD detector 173; an X-Ray Diffraction (XRD) detector rotation mechanism 168; an X-Ray Power supply 174; an X-Ray tube cooling system 175; an XRD power supply 176; an electronic module 177; and optics 178. The operation of the ARL 9900 Spectrometer is described in further detail at https://dokumen.tips/documents/user-manual-xrf-9900.html (available at: https://web.archive.org/web/20210322223412/https://dokumen.tips/documents/user-manual-xrf-9900.html), which is incorporated herein by reference in its entirety for all purposes.

In FIG. 2, four positions (labelled 1-4) are shown. Steps that occur in the ARL 9900 are described below in Table 1, together with an associated position of the four depicted positions:

TABLE 1

| | | Sample end |
|---|---|---|
| Step | Process | position |
| 1 | Take sample using sample changer | 1 |
| 2 | Lower sample down from sample changer to | 2 |
| | sample conveying system and close the | |
| | shutter | |
| 3 | Make a vacuum in the transitional chamber | 2 |
| | comprising the sample holder, shutter lid and | |
| | input lift | |
| 4 | Move sample to under the X-ray tube | 3 |
| 5 | Lift sample from sample conveying system up | 4 |
| | to sample analysis position using the X-ray lift | |
| 6 | Analysis of sample | 4 |
| 7 | Lower sample down from sample analysis | 3 |
| | position to conveyor using the X-ray lift | |
| 8 | Move sample to the input lift | 2 |
| 9 | Vent the transitional chamber and then open | 2 |
| | shutter | |
| 10 | Lift sample to the sample handler, for | 1 |
| | example for disposal and re-loading the next | |
| | sample | |

The transfer assembly of the ARL 9900 is shown in isolation in more detail in FIG. 3. The transfer assembly is an apparatus 110 that comprises two longitudinal guiding elements 120 and 121, which are straight, elongate rods that are spaced apart horizontally and which run longitudinally between a starting position at one end of the rods and an end position at the opposite end of the rods. A carriage 130 for holding a sample holder is attached to the two longitudinal guiding elements 120 and 121. Although no sample holder is shown in FIG. 3, the carriage 130 comprises a circular opening for receiving and retaining a sample holder (not shown). The carriage is configured to engage the longitudinal guiding elements 120 and 121 so as to be guided thereby. The two longitudinal guiding elements 120 and 121 act as a pair of tracks or rails so that in use, the carriage 130 can slide or otherwise move along the longitudinal guiding elements 120 and 121 between a starting position of the carriage 130 and an end position of the carriage 130. For example, a motorised pulley system can be used to move the carriage 130 along the longitudinal guiding elements 120 and 121 between the starting and end positions. The transfer assembly 110 thus acts as a guide assembly (which may be considered as being all of the components that contribute to causing a sample holder to move along a path) configured to move a sample holder between a starting position and an end position.

While this transfer assembly offers good performance for XRF analysis, its throughput can be improved. Moreover, it will be understood that speed of use and the efficiency of transfer assemblies of various other analytical instruments can be improved.

It is known to use rotational sample conveying systems, which move a plurality of sample holders to provide high throughput. However, rotational systems take up a significant amount of space due to the area swept out by the components of such systems and space is often at a premium in analytical instruments. Due to the area of a circle increasing with the square of its radius, this effect is particularly pronounced when rotational systems are provided for moving sample holders over long distances.

Accordingly, it is an object of this disclosure to address these and other problems with known apparatus for moving samples holders.

### SUMMARY OF THE DISCLOSURE

Against this background and in accordance with a first aspect, there is provided an apparatus for moving first and second sample holders between respective first and second starting positions and respective first and second end positions, as defined in claim 1. In a further aspect, there is provided an analytical instrument, as defined in claim 24.

The present disclosure provides apparatus for moving sample holders for use in various instruments, including XRF spectrometers such as the ARL 9900. The apparatus described herein provide a dual sample loading mechanism that allows for processing of two samples at the same time, and for exchanging them directly in a spectrometer chamber, in a robust and compact arrangement. The present disclosure improves sample change times and increases sample throughput while maintaining spectrometer functionality and keeping the space used approximately the same as in known apparatus such as the apparatus 110 of FIG. 3.

One advantageous feature of the disclosure is the provision of a dual sample loader that allows multiple sample holders to be moved in more than one direction simultaneously. This can be achieved by guiding two or more sample holders along distinct paths that are laterally spaced apart from each other (for at least a portion of their path lengths) by a sufficiently large distance to allow at least one sample holder to travel from its end position while at least one other sample holder travels to its end position. This also means that one sample can be analysed at an analysis position while another sample can be prepared at a loading position. In this way, the loading and unloading of the sample holders can be performed in an overlapping or partially overlapping fashion, thereby saving time and improving throughput. In the context of the disclosure, the longitudinal direction is the direction between the starting and end positions of the sample holders, while a lateral direction is a direction perpendicular to the longitudinal direction.

Moving a sample into a vacuum chamber and to an analysis position takes time, not only because of the movement of the sample itself, but also because loading of the sample should not disrupt the vacuum in the main chamber used for analysis. Therefore, there may be a smaller transitional chamber for loading of the sample, which is pumped to a vacuum before it is opened into the main chamber. Therefore, it is advantageous for one sample to be analysed and for another sample to be loaded and prepared for analysis at the same time.

The present disclosure provides a number of advantageous embodiments that provide these and other benefits. In some embodiments, sample holders are moved back and forth along parallel paths that are spaced apart for the entirety of their length. In other embodiments, sample holders are guided along curved paths that diverge from each other to provide space for the sample holders to move in opposite directions without colliding. Various guide assemblies are disclosed for this purpose, which may include longitudinal guiding elements and lateral (i.e. perpendicular to the longitudinal direction between the start and end positions). Moreover, some embodiments employ surfaces of material (e.g. plates) defining curved paths in their surfaces (e.g. having channels in their surfaces, such as grooves that provide a recess in the surface, or openings that pass through the whole depth of the surface), the curved paths being arranged to receive guiding pins in sample holder carriages or cassettes, so as to guide sample holders smoothly along complex paths. In some embodiments, surfaces defining curved paths can be supplemented with additional guiding elements such as guiding rods, and two-part carriages that permit complex motion of sample holders can be used. Such arrangements may be suitable for moving sample holders without risking tilting the sample holders, which may be particularly useful for liquid or powder samples.

In one preferred embodiment, two samples can be processed at the same time using a linear (not rotating) transfer assembly, in which the two samples are exchanged in the sample chamber. This improves the sample change time and increases sample throughput compared to the existing linear sample changer with only single sample loading. Furthermore, it has smaller space requirements than a rotating sample changer. In this embodiment, the transfer assembly comprises two sample carriages instead of the one in existing designs. Both carriages start and end at the exact same places and move past each other in the middle. The carriages each comprise two main parts: a first part that moves longitudinally using linear guiding and a second part holding the sample holder that moves laterally (typically vertically). This lateral movement allows the samples to move past each other. The vertical movement of the second part is achieved using a guiding pin, which moves in a predefined path, including vertical displacement, as the first part moves horizontally with linear guiding. This solution also allows the required manipulation without risk of tilting the sample. Thus, benefits of this embodiment include space saving, allowing sample exchange in very limited space, preferably under vacuum; minimal changes to the existing system, allowing an existing system to keep all its functionalities; and a highly reliable and robust motion assembly by augmenting proven (linear) guiding.

It will be understood that the apparatus described herein can be provided without sample holders, as the sample holders may be disposable or replaceable. Therefore, the apparatus for moving sample holders described herein may be provided as standalone apparatus.

Thus, the disclosure provides a number of benefits including: saving space, allowing sample exchange in very limited space, optionally under vacuum; allowing retrofitting of the apparatus disclosed herein into existing systems to improve throughput; and providing highly reliable and robust motion through the guide assemblies described herein. These and other advantages will become apparent from the following description.

### LISTING OF FIGURES

The present disclosure will now be described by way of example, with reference to the accompanying figures, in which:

FIG. 1 shows schematically a known transfer assembly in situ an ARL 9900;

FIG. 2 shows schematically the operation of the known transfer assembly of an ARL 9900;

FIG. 3 shows schematically the known transfer assembly of the ARL 9900 in isolation;

FIG. 4 shows schematically an apparatus for moving first and second sample holders according to a first embodiment;

FIG. 5 shows schematically an apparatus for moving first and second sample holders according to a second embodiment;

FIG. 6 shows schematically an apparatus for moving first and second sample holders according to a third embodiment;

FIG. 7 shows schematically an apparatus for moving first and second sample holders according to a fourth embodiment;

FIG. 8 shows schematically a rear view of the apparatus of the fourth embodiment;

FIG. 9 shows schematically a close-up view of a carriage of the apparatus of the fourth embodiment;

FIG. 10 shows schematically an exploded view of the carriage of the fourth embodiment;

FIG. 11 shows schematically the paths traversed by the first and second sample holders of the fourth embodiment;

FIG. 12 shows schematically the apparatus of the fourth embodiment in situ in an ARL 9900;

FIG. 13 shows schematically an apparatus for moving first and second sample holders according to a fifth embodiment;

FIG. 14 shows schematically the apparatus of the fifth embodiment;

FIG. 15 shows schematically an apparatus for moving first and second sample holders according to a sixth embodiment;

FIG. 16 shows schematically an apparatus for moving first and second sample holders according to a seventh embodiment;

FIG. 17 shows schematically a rear view of the apparatus of the seventh embodiment;

FIG. 18 shows schematically a rear view of the apparatus of the seventh embodiment;

FIG. 19 shows schematically an exploded view of the carriage of the seventh embodiment;

FIG. 20 shows schematically the apparatus of the seventh embodiment in an ARL 9900;

FIG. 21 shows schematically the apparatus of the seventh embodiment in an ARL 9900;

FIG. 22 shows schematically the apparatus of the seventh embodiment in an ARL 9900;

FIG. 23 shows schematically the apparatus of the seventh embodiment in an ARL 9900;

FIG. 24 shows schematically the apparatus of the seventh embodiment in an ARL 9900;

FIG. 25 shows schematically a sample holder for use in the embodiments described herein; and

FIG. 26 shows schematically a comparison of the spatial requirements of linear transfer assemblies and rotational assemblies.

### DETAILED DESCRIPTION OF PREFERRED EMBODIMENTS

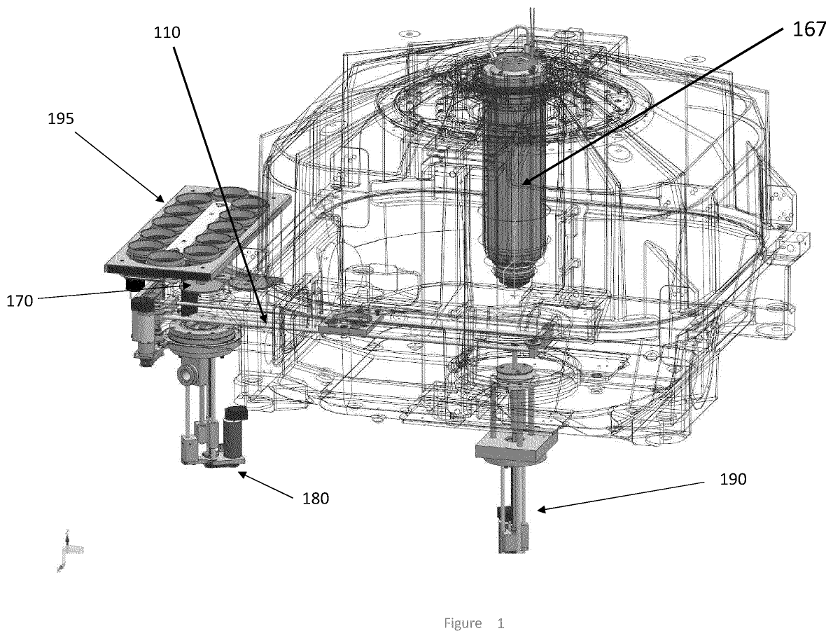

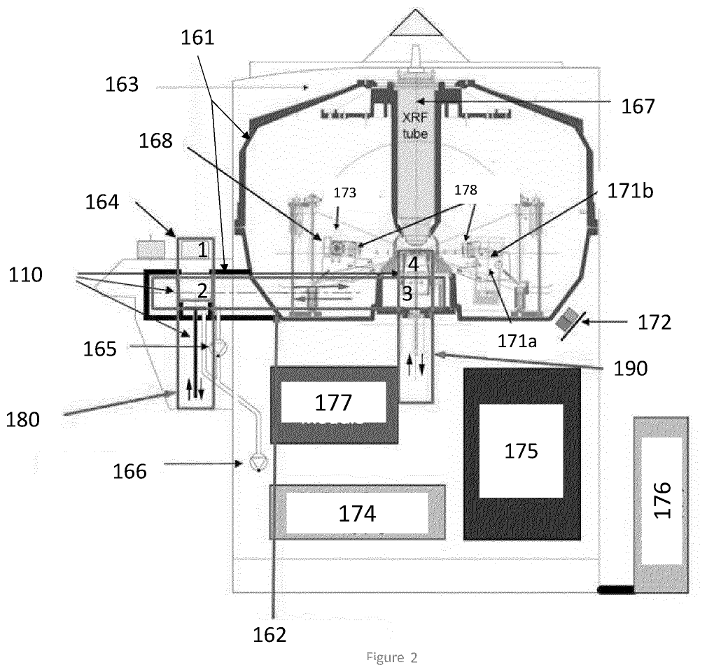

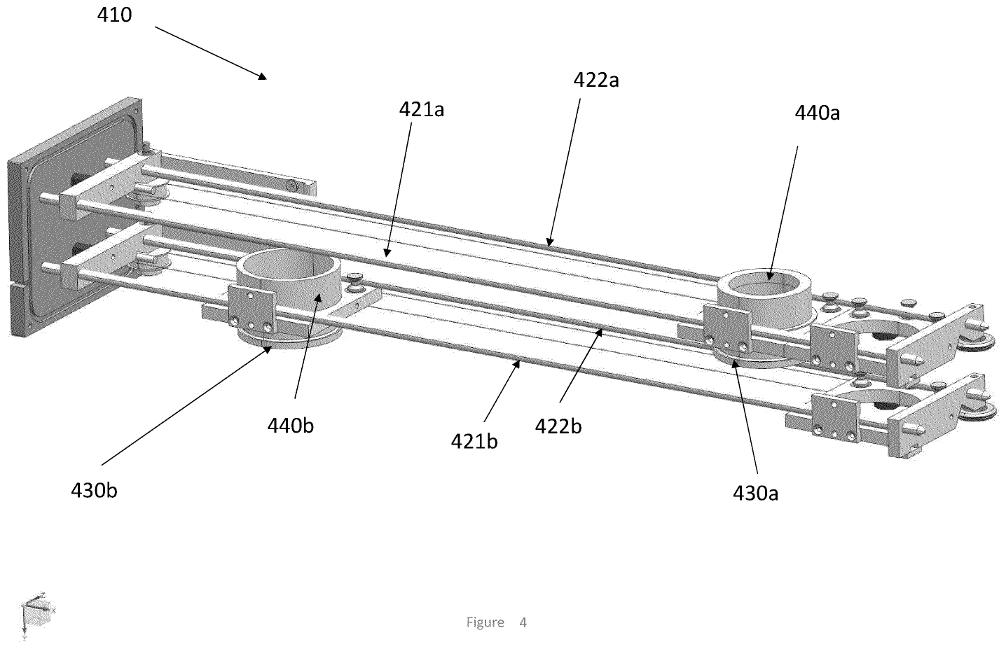

As described previously, FIGS. 1 to 3 illustrate the transfer assembly of the ARL 9900 XRF spectrometer. In FIG. 4, there is shown an apparatus 410 for moving first and second sample holders according to a first embodiment of the present disclosure. The apparatus 410 of the first embodiment may be used in an ARL 9900 in a similar way as described previously.

Like the known transfer assembly 110 of the ARL 9900, the apparatus 410 comprises a first pair of longitudinal guiding elements 421a and 422a, which are straight, elongate rods that are spaced apart horizontally and parallel and which run longitudinally between a starting position at one end of the rods and an end position at the opposite end of the rods. A first carriage 430a for removably holding a first sample holder 440a engages the first pair of longitudinal guiding elements 421a and 422a. The first pair of longitudinal guiding elements 421a and 422a act as a pair of tracks or rails so that in use, the first carriage 430a can be translated between: a starting position at one end of the first pair of guiding elements 421a and 422a; and an end position at the opposite end of the guiding elements 421a and 422a. The apparatus 410 therefore acts as a guide assembly configured to move the first sample holder 440a between a starting position and an end position along a first path.

In addition to the first pair of longitudinal guiding elements 421a and 422a, a similar, second pair of longitudinal guiding elements 421b and 422b is provided directly below (in normal use) the first pair 421a and 422a. The second pair of longitudinal guiding elements 421b and 422b allows a second carriage 430b and an associated second sample holder 440b to undergo translational motion in a direction parallel to, but spaced apart from, the motion of the first sample holder 440a. The first sample holder 440a moves along a first path through space, which is a straight line that is at a distance from the first pair of longitudinal guiding elements 421a and 422a. This distance is determined by the geometry of the first carriage 430a, which mechanically couples the first sample holder 440a to the first pair of longitudinal guiding elements 421a and 422a. Similarly, the second sample holder 440b moves along a second path through space, which is also a straight line that is offset from the second pair of longitudinal guiding elements 421b and 422b by a distance determined by the geometry of the second carriage 430b. The first and second sample holders 440a and 440b thereby move along two paths that are vertically spaced apart. The starting position of the first sample holder 440a is spaced apart from the starting position of the second sample holder 440b and the same is true of the end positions of the sample holders 440a and 440b.

This arrangement allows improved throughput to be obtained when compared with the transfer assembly 110 of FIGS. 1 to 3. For example, while the first sample holder 440a is being used for analysis at one end of the guiding elements 421a and 422a, the second sample holder 440b may be at the other end of its guiding elements 421b and 422b where it may be simultaneously reloaded. Thus, when the first sample holder 440a has been used for analysis, it can be withdrawn and the second sample holder 440b can be caused to move to the end of its guiding elements 421b and 422b and can immediately be used for analysis. Thus, throughput may be improved. Moreover, since this is a linear, translational arrangement rather than a rotational (e.g. carousel-type sample holder) arrangement, spatial requirements are not significantly increased, which helps to facilitate retrofitting of the apparatus 410 in existing instruments having tight spatial constraints.

In order to effect motion of the carriages 430a and 430b and the sample holders 440a and 440b, the apparatus may comprise a controller, which is not shown, configured to cause a motor, which is also not shown, to cause the carriages 430a and 430b and the sample holders 440a and 440b to move along their respective paths. For example, mechanical end stops (similar to those used in the ARL 9900) may be used to define the starting and end positions of the carriages 430a and 430b and the sample holders 440a and 440b. For instance, a Dual Sample Loading Controller (DSLC) may detect the position of the carriages 430a and 430b and the sample holders 440a and 440b according to feedback from stepper motors. Two stepper motors are preferably provided, providing one for each carriage 430a and 430b, although only one common stepper motor could be used for moving both carriages 430a and 430b. It is possible also to include additional sensors for sensing the positions of the carriages 430a and 430b and feedback from the additional sensors may be used to control their positions. Moreover, timing circuitry can be used, to ensure that the carriages 430a and 430b move at appropriate times to prevent both sample holders 440a and 440b being at the same end of their respective pairs of guides at any time. It will be thus understood that various mechanisms for controlling the motion of the sample holders 440a and 440b can be implemented.

It will be appreciated that many variations can be made to the first embodiment. For example, any number of carriages and sample holders can be provided, such as three, four or more than four, by providing additional guiding elements similar to those described above. Moreover, while each carriage 430a and 430b is attached to two guiding elements 421a, 422a, 421b and 422b, more than two or fewer than two can be used. Furthermore, the guiding elements 421a, 422a, 421b and 422b can be curved or of any arbitrary shape. For example, where spatial constraints of an instrument prohibit the use of straight guiding elements, the guiding elements 421a, 422a, 421b and 422b can be modified to be curved. Additionally, cylindrical sample holders 440a and 440b are shown, but any other shape can be used. If sample holders having another shape are used, then the carriages can have a complementary shape to hold the sample holders.

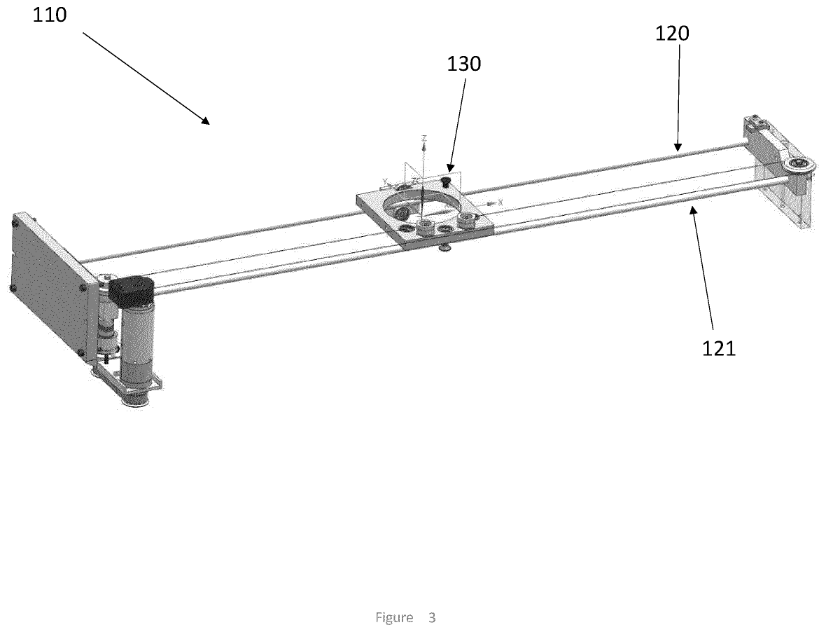

In a general sense, there is provided an apparatus for moving first and second sample holders (e.g. the sample holders 440a and 440b) between respective first and second starting positions (e.g. one end of the guiding elements 421a, 422a, 421b and 422b) and respective first and second end positions (e.g. the other end of the guiding elements 421a, 422a, 421b and 422b). The apparatus comprises a guide assembly (which in this case comprises the guiding elements 421a, 422a, 421b and 422b and the carriages 440a and 440b), configured to: guide the first sample holder along a first path from the first starting position to the first end position and back along the first path from the first end position to the first starting position; and guide the second sample holder along a second path from the first starting position to the second end position and back along the second path from the second end position to the second starting position. The guide assembly is configured such that the first and second sample holders are spaced apart as they move along at least a portion of the lengths of their respective paths. Thus, a dual sample loading apparatus is provided that is more compact than an equivalent rotational dual sample loading apparatus and which provides improved throughput compared to the apparatus of FIG. 3. It will be understood that the apparatus can be provided as a standalone apparatus without sample holders, as the sample holders may be disposable and/or replaceable.

The paths of the sample holders may be parallel at or near: the first and second starting positions; and/or the first and second end positions. By ensuring that the sample holders depart on parallel trajectories from the starting position and/or arrive at the end position on parallel trajectories, loading and/or unloading of the sample holders can be achieved more easily. For example, if the sample holders are loaded and/or unloaded in different orientations (e.g. because they face in different directions at the starting and/or end positions) then it may be difficult to align the sample holders with lifts and/or vacuum chambers. This parallel arrangement thus reduces some of the difficulties of aligning lifts and the like with multiple sample holders. The first and/or second starting positions may be a sample loading position; and/or the first and/or second end positions may be a sample analysis position or a sample unloading (e.g. deposition) position.

The guide assembly may be configured such that the paths are spaced apart in a direction that is substantially perpendicular to the paths. For instance, the paths may be spaced part in the vertical direction (e.g. as shown in FIG. 4), which is substantially perpendicular to the longitudinal paths of the first and second sample holders. Spacing apart the paths in this way provides space for the sample holders to move along their respective paths without colliding, facilitating improved throughput due to the dual loading and/or unloading mechanism. The guide assemblies of the present disclosure may be configured such that the paths are spaced apart for some or all of their lengths.

The guide assemblies described herein may comprise one or a plurality of longitudinal guiding elements configured to guide the sample holders longitudinally along their respective paths (e.g. in the direction extending between their starting and end positions). For instance, linear, longitudinal rods (such as elements 421a, 422a, 421b and 422b) may be provided, so two longitudinal guiding elements (or one, or more than two) such as rods may be provided per carriage. Longitudinal guiding allows the carriages and sample holders to be moved between their starting and end positions. In some instances, the use of horizontal guiding may assist in ensuring that the sample holders are held in a substantially flat orientation (e.g. horizontally) so that the samples stored therein are not disturbed or spilled as the sample holders move along their paths. Preferably, the one or a plurality of longitudinal guiding elements comprise longitudinal guiding rods. Such longitudinal guiding rods may be straight or curved.

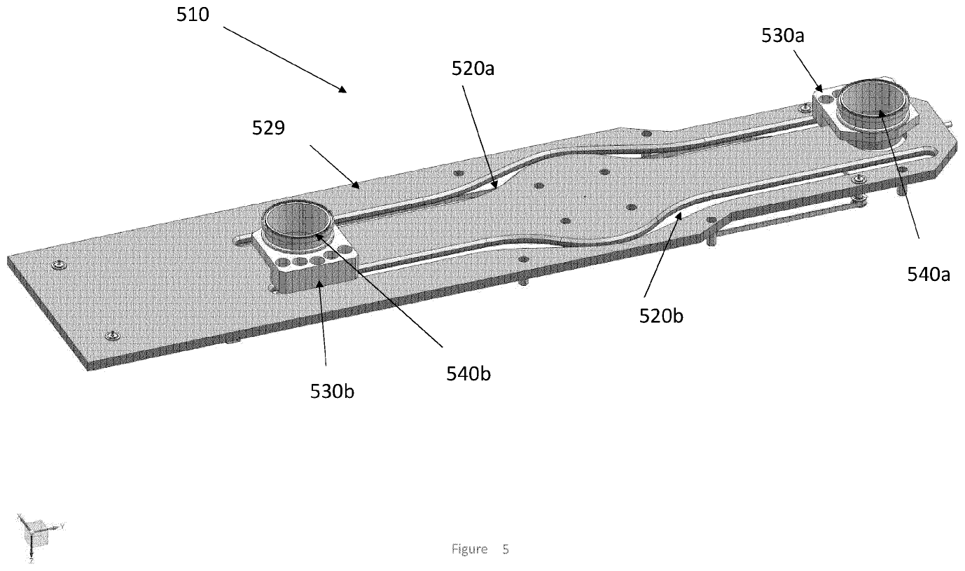

Turning next to FIG. 5, there is shown an apparatus 510 for moving first and second sample holders 540a and 540b between respective first and second starting and end positions in accordance with a second embodiment. Unlike the first embodiment, the sample holders 540a and 540b of the second embodiment start and end in the same position, which helps with aligning the sample holders 540a and 540b with lifts and vacuum pumps. Moreover, the second embodiment is more compact than the first embodiment.

The apparatus 510 comprises a surface 529 (which is shown as being substantially flat and planar, but which need not be flat or planar) defining longitudinal guiding elements 520a and 520b, which guide the carriages 530a and 530b along their paths. The guiding elements 520a and 520b also act to provide lateral (i.e. in a direction within the plane of the surface 529 that is perpendicular to the general, longitudinal direction of the paths of the carriages) guiding and separation for the carriages 530a and 530b. In this case, the guiding elements 520a and 520b are elongate channels in the surface 529 that extend through the surface 529, rather than elongate rods as described previously. Accordingly, the carriages 530a and 530b have a protrusion or mechanical coupling (e.g. a guiding pin, ridge, lip or flange) to allow the carriages 530a and 530b to be securely held in the guiding elements 520a and 520b so that the sample holders 540a and 540b follow the paths defined by the guiding elements 520a and 520b. In use, the surface 529 is positioned substantially horizontally so that the plane 529 of the surface is parallel with the ground, with the guiding elements 520a and 520b being spaced apart in the horizontal plane. Similarly to the first embodiment, the apparatus 510 comprises first and second carriages 530a and 530b, which cause respective first and second sample holders 540a and 540b to move along first and second paths between their start and end positions.

The first carriage 530a sits within and extends from its guiding element 520a towards the centre of the guiding elements 520a and 520b, so as to hold the first sample holder 540a in a position between the guiding elements 520a and 520b. Similarly, the second carriage 530b sits within and extends from its guiding element 520b towards the centre of the guiding elements 520a and 520b, so as to hold the second sample holder 540b between the guiding elements 520a and 520b. One guiding element is provided per carriage, although multiple such guiding elements could be provided. The surface 529 defining the guiding elements 520a and 520b and the carriages 530a and 530b function together as a guide assembly for the first and second sample holders 540a and 540b. This guide assembly is configured to guide the first sample holder 540a along a first path from its starting position to its end position and back along the first path, and to guide the second sample holder 540b along a second path from its starting position to its end position and back along the second path.

In this embodiment, the paths of the first and second sample holders 540a and 540b diverge at their centres. The paths traversed by the first and second sample holders 540a and 540b are essentially parallel and coincident at the start and end positions, but are spaced apart in the middle to provide space for the first and second sample holders 540a and 540b to move past each other. In particular, the paths traversed by the first and second sample holders 540a and 540b diverge towards the middle. This makes it easier to use a single sample loading or unloading mechanism for both sample holders 540a and 540b. Because the sample holders 540a and 540b have identical starting and end positions, major realignment of sample loading or unloading mechanisms is not required each time the sample holders 540a and 540b move to or from their starting or end positions. Moreover, the second embodiment has lower spatial requirements than the first embodiment, with similarly high throughput.

Many variations to the second embodiment will be apparent to the skilled reader. The precise shape of the guiding elements 520a and 520b can be curved or of any arbitrary shape, and one or both of the paths defined by the guiding elements 520a and 520b can be straight. While a flat surface 529 is depicted, the surface 529 need not be flat, and could be a solid material having a substantial depth. Additionally, cylindrical sample holders 540a and 540b and corresponding carriages 530a and 530b are shown, but any other shape can be used. In this case, the guiding elements 520a and 520b are elongate channels that extend the whole way through the surface 529, although the guiding elements 520a and 520b could instead be grooves in the surface 529 that do not extend through the surface 529 (e.g. that provide a recessed portion in the surface 529).

The second embodiment is particularly well-suited to having additional numbers of guiding elements 520a and 520b, carriages 530a and 530b, and sample holders 540a and 540b, because the sample holders do not need to overcome gravity. Where additional sample holders and carriages are provided, a third carriage (and optionally any other number of carriages) may be moved and temporarily stored out of the way of the first and second sample holders so as not to block them (e.g. between loading and analysis position).

Thus, returning to the general terms used previously, there is provided an apparatus for moving first and second sample holders, in which the starting positions of each of the sample holders are the same; and/or the end positions of each of the sample holders are the same. The paths of the sample holders may therefore coincide at the starting and/or end positions. This arrangement provides an apparatus for moving sample holders that can be retrofitted into existing instruments having loading and/or unloading mechanisms designed for single-carriage transfer assemblies. The apparatus described herein can be installed easily in such instruments due to the loading and/or unloading positions being the same, which means the original loading and/or unloading mechanisms can continue to be used. Moreover, having a single starting position and/or a single end position can make it easier to provide a sealed vacuum chamber.

The guide assemblies described herein may be configured such that the separation between the paths varies along the lengths of the paths. For instance, the paths may initially coincide and then diverge towards their centres, so as to provide space for the sample holders to move past each other without colliding, as shown in FIG. 5. For example, the guide assembly may be configured such that the first and second paths are spaced apart along at least a portion of their lengths, to permit the sample holders simultaneously to move in opposite directions along their respective paths (e.g. to provide space for the sample holders to pass each other). Hence, the guide assemblies of the disclosure may be configured such that the paths are spaced apart for only a portion of their lengths. A distance between the paths may be greater at or near a centre of the paths than at: one end of the paths; or at both ends of the paths. To that end, the guide assembly may be configured such that at least one and preferably each of the paths comprise: a curved portion; and/or a substantially straight portion. One or more of the paths may comprise two or more straight portions, with a curved portion in between to provide space for the sample holders to pass each other. Alternatively, one or more of the paths may comprise a plurality of straight portions each joined by angled portions.

In order to provide the curved paths described herein, a curved channel (e.g. guiding elements 520a and/or 520b) in a surface (e.g. surface 529) can be provided. Such a curved channel may act as a longitudinal guiding element, because it causes the sample holders to move generally in the longitudinal direction between their starting and end positions. Moreover, such a curved channel may simultaneously act as a lateral guiding element because it causes the sample holders to move laterally (i.e. in a direction perpendicular to the longitudinal direction extending between their starting and end positions). Thus, some embodiments of the present disclosure comprise one or a plurality of lateral guiding elements (e.g. guiding elements 520a, 520b) configured to: guide the sample holders laterally as they move along their respective paths; and/or vary the separation between the paths. Such lateral guiding allows sample holders to pass by each other without colliding, facilitating improved throughput over conventional linear transfer assemblies.

While two curved paths are shown in the second embodiment, it will be understood that similar advantages could be achieved using only one curved path, with the other path being substantially straight. To achieve this, a straight channel could be provided in the surface 529 for one of the sample holders 540a and 540b, and the other of the same holders 540a and 540b could be caused to follow a curved path by virtue of a curved channel in the surface 529.

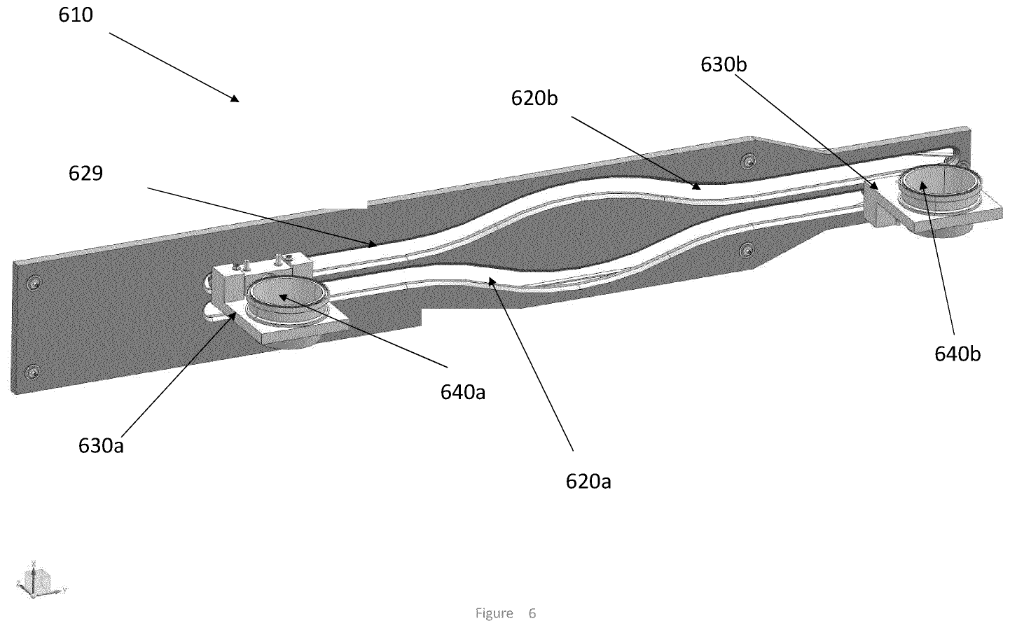

Turning next to FIG. 6, there is shown an apparatus 610 for moving first and second sample holders 640a and 640b between respective first and second starting and end positions in accordance with a third embodiment. This embodiment again provides sample holders 640a and 640b that start and end in the same positions, providing space savings.

The third embodiment also comprises a surface 629, which may be substantially flat or planar, that defines guiding elements 620a and 620b, which guide a first carriage 630a and a second carriage 630b along their paths between starting and end positions at each end of the guiding elements 620a and 620b. The surface 629 is similar to the surface 529 of FIG. 5, but is oriented vertically rather than horizontally during normal use. Moreover, the sample holders 640a and 640b of the third embodiment are substantially the same as the sample holders of the first and second embodiments.

The carriages 630a and 630b of the third embodiment differ from the carriages 530a and 530b of the second embodiment in that they extend in a direction that is perpendicular to the surface 629. In use, the axes of the generally cylindrical sample holders 640a and 640b are vertical and parallel to the surface 629, whereas in the second embodiment the axes of the generally cylindrical sample holders 540a and 540b are vertical and perpendicular to the surface 529. The apparatus 610 of the third embodiment is particularly suited for use in instruments in which vertical spatial constraints are less strict than horizontal spatial constraints. This is in contrast to the second embodiment, which is more suited for use in instruments where vertical spatial constraints dominate.

In the general terms used previously, the guiding elements 620a and 620b may simultaneously act as longitudinal guiding elements and as lateral guiding elements. This is because they cause the sample holders 640a and 640b to move longitudinally between the starting and end positions, while also causing the separation between the paths of the sample holders 640a and 640b to vary along the lengths of their paths. Similarly to the embodiment shown in FIG. 5, this provides space for the sample holders to pass each whilst the sample holders 640a and 640b simultaneously move in opposite directions along their respective paths.

Many variations to the third embodiment can be made. For example, other numbers of guiding elements 620a and 620b, carriages 630a and 630b, and sample holders 640a and 640b can be provided. Moreover, the precise path defined by the guiding elements 620a and 620b can be curved or of any arbitrary shape, and one or both of the paths defined by the guiding elements 620a and 620b can be straight. A flat surface 629 is depicted, but the surface 629 can be of any shape. Moreover, a further such surface can be provided facing the surface 629 to provide further guiding of the carriages 630a and 630b and to improve stability. Moreover, other shapes can be used for the sample holders 640a and 640b and carriages 630a and 630b can be used. The guiding elements 620a and 620b are channels that extend the whole way through the surface 629, although the guiding elements 620a and 620b could instead be grooves in the surface 629 that do not extend through the surface 629.

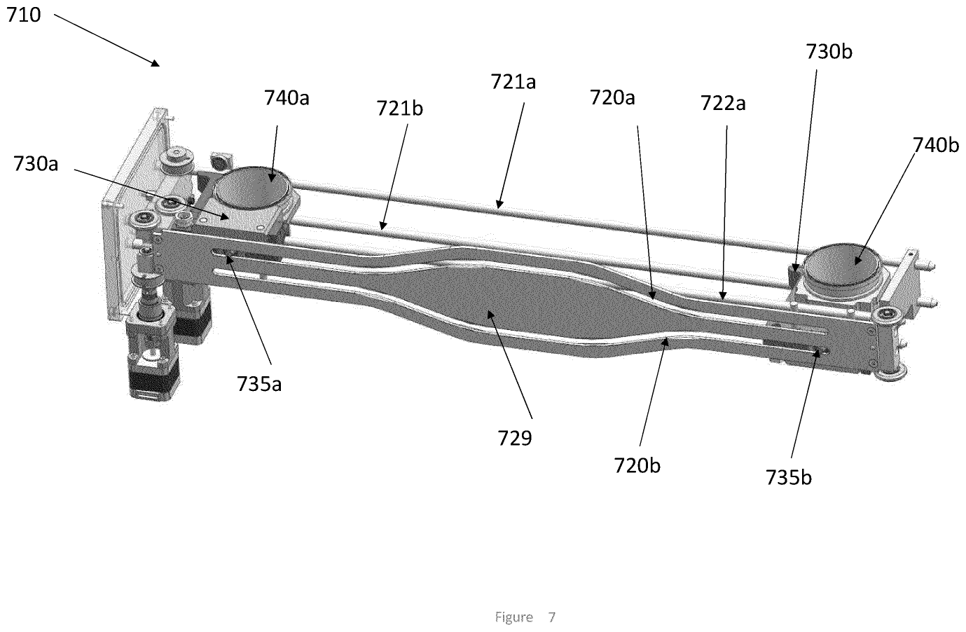

Turning next to FIG. 7, there is shown an apparatus 710 for moving first and second sample holders 740a and 740b according to a fourth embodiment. The fourth embodiment is similar in some respects to a combination of the first and third embodiments described above. The fourth embodiment provides a more robust guiding system than the previous embodiments shown in FIGS. 5 and 6, which have curved paths that require precise machining to reproduce. The fourth embodiment provides a surface 729 that is similar to the surfaces 529 and 629 of the second and third embodiments, but provides additional guiding to reduce or prevent the sample holders tilting, in order to achieve smooth guiding of sample holders. As in the second and third embodiments, the sample holders 740a and 740b start and end in the same positions, allowing for the apparatus 710 to be fitted into existing systems with minimal modifications required.

The apparatus 710 as shown in FIG. 7 has a guide assembly that again comprises a flat surface 729, which is substantially similar to the flat surface 629 of the third embodiment. The flat surface 729 defines guiding elements 720a and 720b, which guide a first carriage 730a and a second carriage 730b along their paths between starting and end positions at each end of the guiding elements 720a and 720b and so act to provide longitudinal guiding.

The guide assembly further comprises a first pair of longitudinal guiding elements 721a and 722a, which in this case are straight, elongate rods that are spaced apart horizontally and which run longitudinally between a starting position at one end of the rods and an end position at the opposite end of the rods. The first pair of longitudinal guiding elements 721a and 722a are similar to the rods 421a and 422a of the first embodiment. Also provided is a second pair of longitudinal guiding elements 721b and 722b, which are also straight, elongate rods that are spaced apart horizontally to guide a second carriage 730b.

The combination of a guiding element 720a in the surface 729 with a first pair of longitudinal guiding elements 721a and 722a provides improved stability of the sample holder 740a over the third embodiment, while retaining similar benefits in terms of space reduction when compared with the first embodiment.

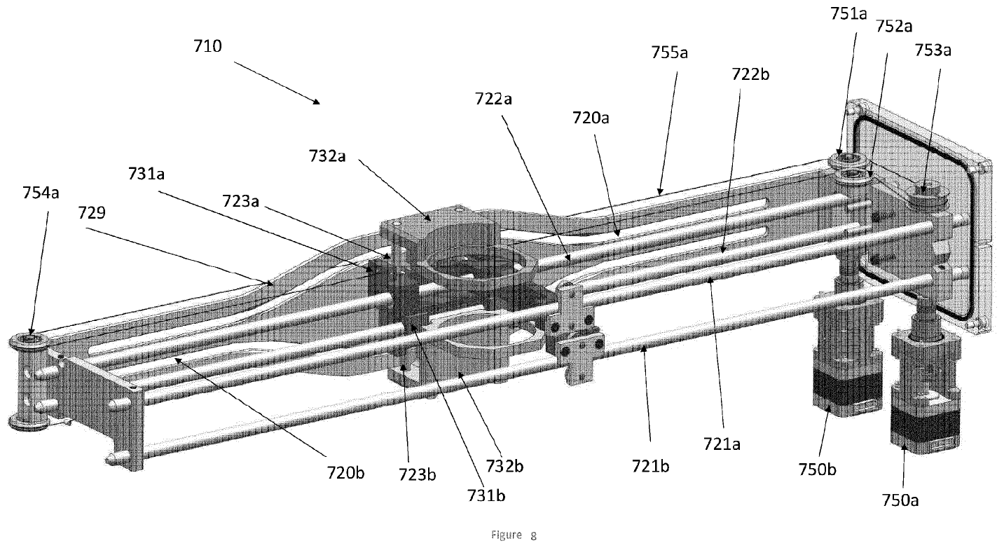

FIG. 8 shows the rear side of the apparatus of FIG. 7, with the sample holders 740a and 740b omitted for clarity. In order for the sample holders 740a and 740b to be caused to follow predefined paths through space using the arrangement of FIG. 7, the carriages 730a and 730b of FIG. 7 are provided as two-part components. The carriages 730a and 730b comprise fixed portions 731a and 731b that are configured to be longitudinally guided by the pairs of longitudinal guiding elements 721a and 722a and 721b and 722b. The pairs of longitudinal guiding elements 721a and 722a and 721b and 722b pass through the fixed portions 731a and 731b and the fixed portions 731a and 731b can slide along the longitudinal guiding elements 721a and 722a and 721b and 722b. The fixed portions 731a and 731b of the carriages 730a and 730b follow substantially straight paths defined by the pairs of longitudinal guiding elements 721a and 722a and 721b and 722b, which are similar to the paths of the carriages 440a and 440b in FIG. 4.

In order to ensure that the sample holders 740a and 740b move along the predefined trajectory defined by the guiding elements 720a and 720b of the flat surface 729, the carriages 730a and 730b further comprise laterally-guided portions 732a and 732b, which are configured to hold the sample holders. The laterally-guided portions 732a and 732b move away (vertically during normal use) from the fixed portions 731a and 731b as the carriages 730a and 730b move between their starting and end points. This is achieved using lateral guiding elements 723a, 724a, 723b and 724b that mechanically couple the fixed portions 731a and 731b and laterally-guided portions 732a and 732b to each other so that they each move together longitudinally. The lateral guiding elements 723a, 724a, 723b and 724b are rods that ensure that the laterally-guided portions 732a and 732b are free to move away from the fixed portions 731a and 731b by a large enough distance to permit the sample holders 740a and 740b to pass by each other as they reach the centres of their respective paths. The lateral guiding elements 723a, 724a, 723b and 724b are rigidly connected to the laterally-guided portions 732a and 732b and pass through openings in the fixed portions 731a and 731b. This ensures that the laterally-guided portions 732a and 732b are free to slide along the paths defined by the guiding elements 720a and 720b, to vary the lateral separation between the sample holders 740a and 740b.

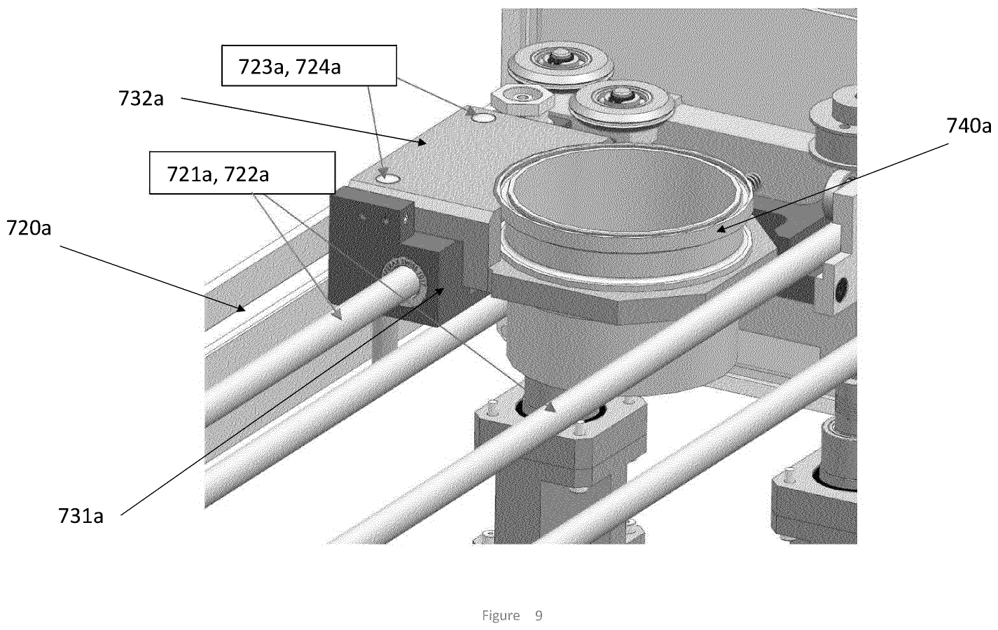

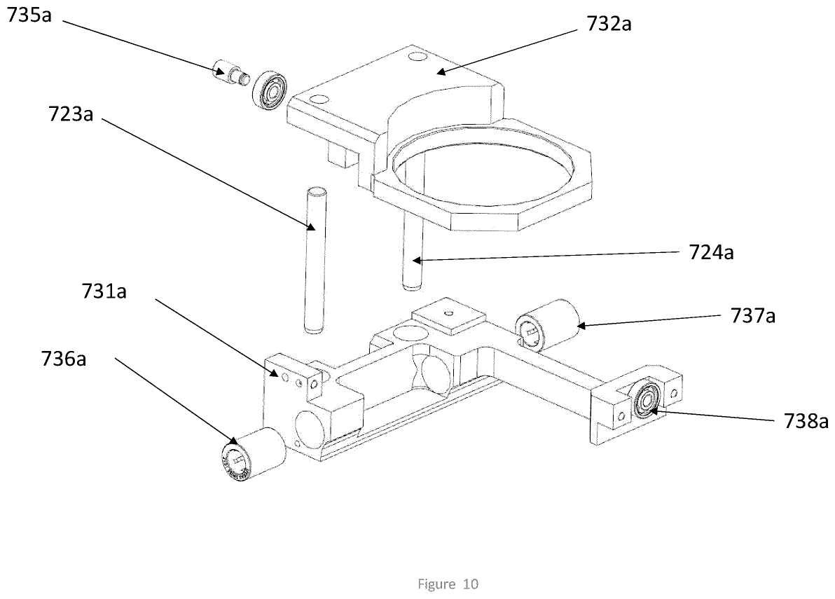

FIG. 8 shows the laterally-guided portions 732a and 732b at the point of maximal separation with the carriages 730a and 730b at the centres of their respective paths, so as to provide space for the sample holders (which are not shown in FIG. 8) simultaneously to move in opposite directions along their respective paths. Thus, in this embodiment, as in the above-described embodiments, one of the sample holders can be in the starting position (loading position) while the other sample holder is in the end position (analysis position) and the sample holders simultaneously move in opposite directions along their respective paths in order to change positions. FIG. 9 shows the upper carriage 730a in its unexpanded state, where the fixed portion 731a and the laterally-guided portion 732a are in contact. The lateral guiding elements 723a, 724a, 723b and 724b constrain and stabilise (e.g. reduce the likelihood of the sample holders 740a and 740b tilting) the laterally-guided portions 732a and 732b of the carriages 730a and 730b as they move away from the fixed portions 731a and 731b. The major individual components of the carriages 730a and 730b are shown in an exploded state in FIG. 10 In this embodiment, the guiding elements 723a and 724a have a diameter of approximately 8 mm and the opening for receiving the sample holder 740a in the laterally-guided portion 732a has a diameter of approximately 82 mm. Of course, other dimensions can be used depending on the size of samples to be transported and the size of the sample holders required.

As shown in FIG. 10, the fixed portion 731a may comprise two linear ball bearings 736a and 737a for engaging the longitudinal guiding element 722a. The longitudinal guiding element 722a passes though the linear ball bearings 736a and 737a. The opposite side of the fixed portion 731a comprises a bearing 738a that, in use, rests on top of the other longitudinal guiding element 721a, as best shown in FIG. 9. While not shown in FIG. 10, the other fixed portion 731b may comprise similar ball bearings for engaging the longitudinal guiding elements 721b and 722b. It will be appreciated that other ways of securing the fixed portions 731a and 731b to the guiding elements could be used.

As in the third embodiment, the laterally-guided portions 732a and 732b comprise protrusions 735a and 735b (e.g. guiding pins) that are configured to engage the guiding elements 720a and 720b defined in the flat surface 729. These protrusions 735a and 735b sit within the guiding elements 720a and 720b so as to cause the laterally-guided portions 732a and 732b and hence the sample holders 740a and 740b to follow curved paths whilst the fixed portions 731a and 731b follow substantially straight, linear paths.

As noted previously, for the purposes of the present disclosure, a guide assembly may be considered to be the components of an apparatus that co-operate to cause a sample holder to move along its path. Thus, in the context of the fourth embodiment, the guide assembly may be considered as comprising: the flat surface 729 and its guiding elements 720a and 720b; the first pair of longitudinal guiding elements 721a and 722a; the second pair of longitudinal guiding elements 721b and 722b; the lateral guiding elements 723a, 724a, 723b and 724b; and the carriages 730a and 730b, thus including the fixed 731a and 731b and laterally-guided 732a and 732b portions thereof.

In the general terms used previously, the apparatus described herein may have one or a plurality of lateral guiding elements and the guide assemblies described herein may comprise at least one carriage (and optionally two or more carriages) configured to move at least one sample holder along its respective path. As shown in FIGS. 7 to 10, one or a plurality of carriages (e.g. each carriage) may comprise one or a plurality of lateral guiding elements. For example, in FIG. 9, two lateral guiding elements 723a, 724a are part of the carriage 730a and the same is true of the other carriage 730b. Thus, improved guiding and stability is provided, as sample holders can be held substantially flat (e.g. horizontally) while being laterally-guided in a smooth manner.

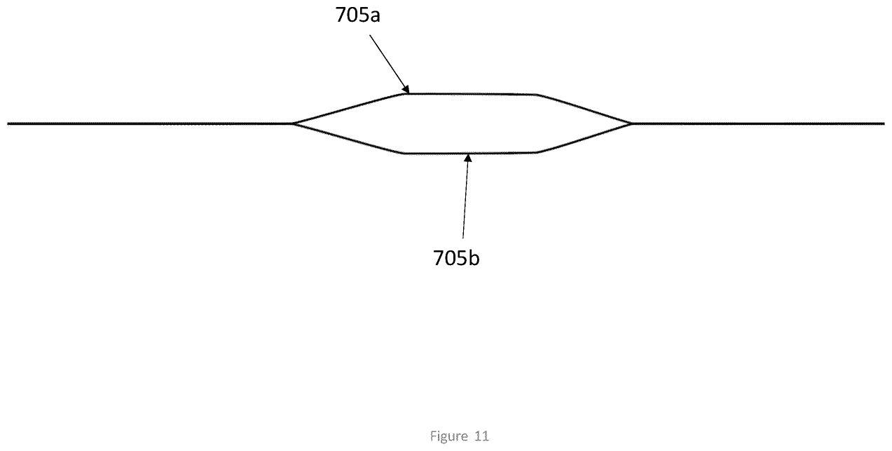

FIG. 11 shows the paths 705a and 705b traversed by the first and second sample holders 740a and 740b of the fourth embodiment. It can be seen that the paths are coincident at the start and end positions, whilst being spaced apart at their centres to provide space for the sample holders 740a and 740b to pass by each other without colliding. As the paths 705a and 705b start and end in the same place, the fourth embodiment can readily be implemented in existing instruments, such as the ARL 9900.

In order to effect motion of the carriages 730a and 730b and the sample holders 740a and 740b, the apparatus comprises motors 750a and 750b (which may be stepper motors), to cause the carriages 730a and 730b and the sample holders 740a and 740b to move along their respective paths. In FIG. 8, the first motor 750a is shown as being connected to the first carriage 730a by a first cord or cable 755a. The first cord or cable 755a connects the first motor 750a to the first carriage 730a by a first plurality of pulleys 751a, 752a, 753a and 754a. the first motor 750a may be mechanically coupled to one of the pulleys 753a to control the motion of the cord or cable 755a. A similar cable and pulley arrangement may be provided for the second motor 750b, but is not shown in FIG. 8, for simplicity. As described previously, mechanical end stops (similar to those used in the ARL 9900) may be used to define the starting and end positions of the carriages 730a and 730b and the sample holders 740a and 740b, or homing positions that can slightly differ from the starting and end positions. For instance, a Dual Sample Loading Controller (DSLC) may detect the position of the carriages 730a and 730b and the sample holders 740a and 740b according to feedback from the stepper motors. In this embodiment, two motors 750a and 750b are provided (one for each carriage 730a and 730b), but one common motor could be used for moving both of the carriages 730a and 730b simultaneously.

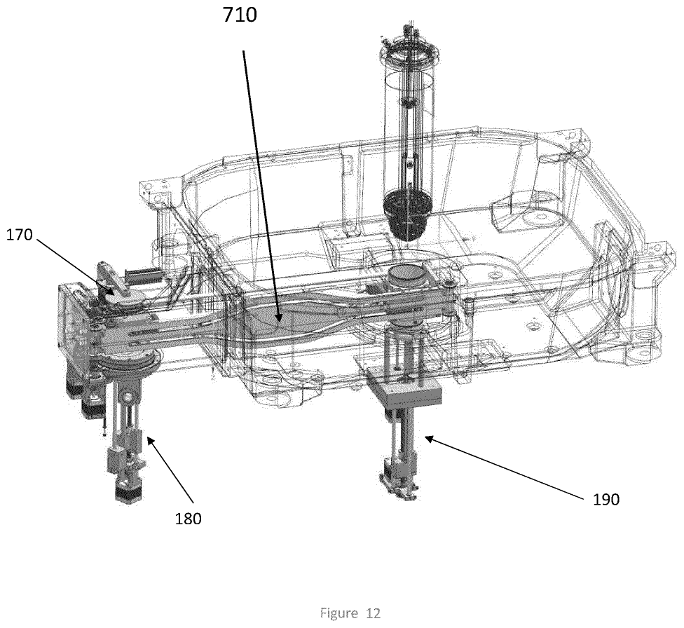

The apparatus 710 of the fourth embodiment is shown in an ARL 9900 in FIG. 12. Here, the apparatus 710 of the fourth embodiment is shown in the same instrument as shown in FIG. 1, comprising a shutter 170, a sample lift 180 and an analysis lift 190. Thus, in a general sense, there may be provided an analytical instrument comprising any of the apparatus described herein and an analyser, wherein the apparatus is configured to move the sample holders to the analyser for analysis of samples within the sample holders. The analytical instrument may be configured to: receive the sample holders in a vacuum chamber of the analytical instrument; and/or to deposit the sample holders in a vacuum chamber of the analytical instrument.

The analysers described herein may comprise at least one of: a spectrometer, a diffractometer, and a microscope, configured to analyse samples using photons, electrons and/or ions. For instance, the analyser may comprise any one or more of an X-ray fluorescence (XRF) spectrometer, X-Ray diffractometer (XRD), an electron microscope, a spark optical emission (OES) spectrometer, a laser-induced breakdown spectroscopy (LIBS) spectrometer, an X-ray photoelectron spectroscopy (XPS) spectrometer, an Auger electron spectroscopy spectrometer, or an electron energy loss spectroscopy (EELS) spectrometer. Various other analytical instruments can benefit from the apparatus described herein. For instance, embodiments described herein may be advantageous in any system that requires analysis under vacuum and in which the analysis time is not especially long compared with the sample handling time. Using the fourth embodiment, sample change times can be reduced in comparison to the examples shown in FIGS. 1 to 3.

Many modifications to the fourth embodiment can be made. For example, other numbers of carriages 730a and 730b and sample holders 740a and 740b can be provided, by providing additional guiding elements similar to those shown. Moreover, the precise path defined by the guiding elements 720a, 721a, 722a, 720b, 721b, 722b can be of any arbitrary shape, and one or both of the paths 705a and 705b can be straight. One flat surface 729 is depicted, but the surface 729 can be of any shape and need not be flat. Moreover, a further such surface can be provided opposing the surface 729 so as to provide additional guiding of the carriages 730a and 730b. Moreover, sample holders 740a and 740b and carriages 730a and 730b having other shapes can be used. The guiding elements 720a and 720b are provided by channels that extend the whole way through the surface 729, although the guiding elements 720a and 720b could instead be grooves in the surface 729 that do not extend the whole way through the surface 729.

In the embodiment of FIGS. 7 to 11, the lateral guiding elements 723a, 724a, 723b and 724b are rigidly connected to the laterally-guided portions 732a and 732b and pass through openings in the fixed portions 731a and 731b. In an alternative implementation, lateral guiding elements could be rigidly connected to the fixed portions and could pass through openings in the laterally-guided portions. In such a case, the lateral guiding elements would protrude through the openings at the ends of their paths, which could cause difficulties due to the protruding portions requiring additional space. In particular, the lateral guiding elements could interfere with the loading and analysing positions and cause collisions. Thus, the arrangement of FIGS. 7 to 11 (in which the lateral guiding elements 723a, 724a, 723b and 724b are rigidly connected to the laterally-guided portions) is preferred.

As noted previously, the smooth, curved paths for the sample holders are achieved through the guiding mechanisms described above. In general terms, at least one of (and optionally a plurality of or all of) the carriages preferably comprises a protrusion configured to engage a complementary channel of the guide assembly, the complementary channel configured to cause the at least one carriage to move at least one of the sample holders along its respective path. The complementary channel may act as a lateral and/or longitudinal guiding element. For instance, the protrusion may be a mechanical coupling, such as a guiding pin, a ridge, a lip, a flange or a notch, configured to fit within an elongate channel to guide a carriage and sample holder along a predefined and optionally curved path. This provides improved control over the paths of the carriages and sample holders. The complementary channel may comprise a curved portion and/or a substantially straight portion to provide a desired path. The complementary channel may comprises an elongate channel in a surface of the guide assembly, configured to engage the at least one protrusion. The channel could be a hole in the surface (i.e. an opening extending through the entirety of the surface) or could simply a depression (e.g. a groove) within the surface that does not penetrate the entire way through the surface. Moreover, a plurality of such surfaces could be provided. For example, in the fourth embodiment, a further, identical surface 729 could be provided on the opposite side of the apparatus 710 to provide additional guiding of the carriages 730a and 730b. Similarly, an additional, identical surface 629 could be provided in the embodiment of FIG. 6.

At least one of the carriages may comprise: a fixed portion that is longitudinally-guided and moves substantially in a straight line between the starting and end points; and a laterally-guided portion for holding a sample holder that moves away from the fixed portion as the carriage moves between the starting and end points. The combination of the different types of guiding (e.g. the different types of longitudinal and lateral guiding) described herein allows for precise control over the alignment of the sample holders at the starting and end positions, and also for separation as the sample holders move along the path. Moreover, stability of the sample holders is provided. The guide assembly may be configured such that the first and second sample holders are held substantially flat as they move along their respective paths. For instance, liquids can be transported in open-topped sample holders with reduced risk of spillage.

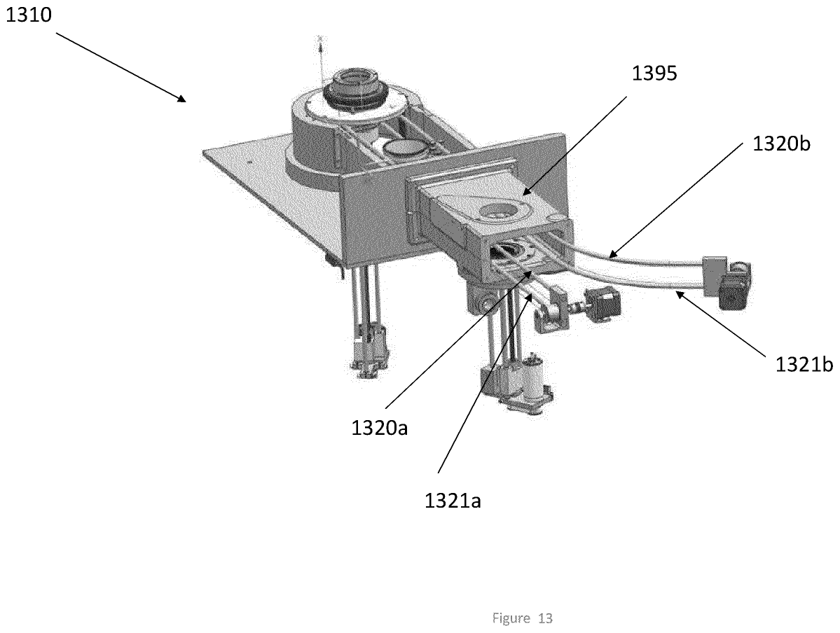

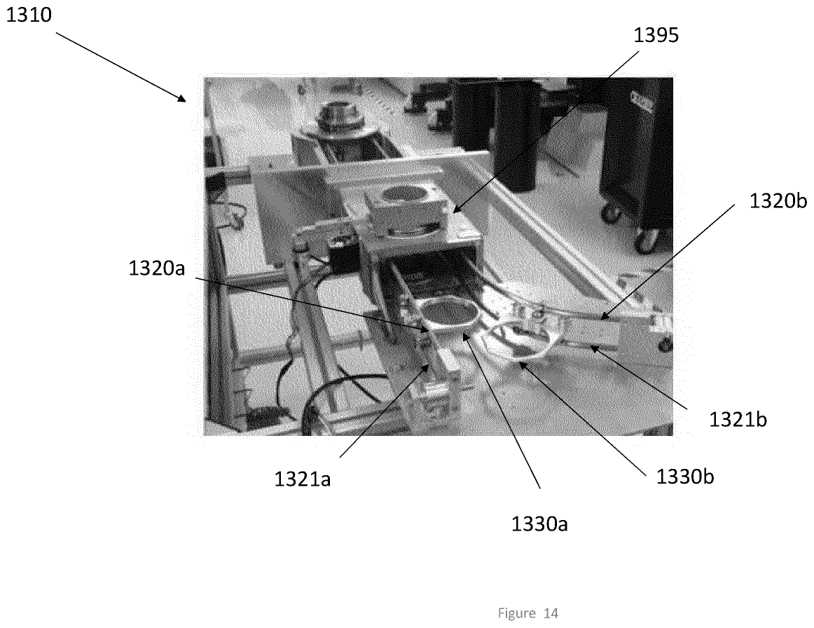

Turning next to FIGS. 13 and 14, there are shown an apparatus 1310 according to a fifth embodiment, with (FIG. 14) and without (FIG. 13) carriages 1330a and 1330b. The apparatus 1310 comprises a main housing 1395, which can be used for providing a region in vacuum. FIG. 13 shows a device having a housing that is partially open, but the housing 1395 can be expanded to encompass the entirety of the paths of the sample holders, so that the entirety of the paths can be in a vacuum. The apparatus 1310 comprises a first pair of longitudinal guiding elements 1320a and 1321a, which are straight, elongate rods that are spaced apart vertically and which run longitudinally between a starting position at one end of the rods outside the housing 1395 and an end position at the opposite end of the rods within the housing 1395. The apparatus 1310 further comprises a second pair of guiding elements 1320b and 1321b, which curve away from the first pair of guiding elements 1320a and 1321a outside the housing 1395. The second pair of guiding elements 1320b and 1321b are again elongate rods that are spaced apart vertically and which run between a starting position at one end of the rods outside the housing 1395 and an end position at the opposite end of the rods within the housing 1395. The sample holders of this embodiment can be made to start and end in the same position.

As shown in FIG. 14, a first carriage 1330a is mechanically coupled to the first pair of guiding elements 1320a and 1321a to permit the first carriage 1330a to run back and forth along the first pair of guiding elements 1320a and 1321a. The first carriage 1330a extends horizontally from the guiding elements 1320a and 1321a (which are spaced apart) towards the second pair of guiding elements 1320b and 1321b. Similarly, a second carriage 1330b is mechanically coupled to the second pair of guiding elements 1320b and 1321b to permit the second carriage 1330b to run back and forth along the second pair of guiding elements 1320b and 1321b. Thus, in this embodiment, the guide assembly may be considered as comprising the first and second pairs of guiding elements 1320a and 1321a and 1320b and 1321b and the carriages 1330a and 1330b.

Due to the curvature of the second pair of guiding elements 1320b and 1321b outside the chamber, the first and second carriages 1330a and 1330b are spaced apart so that, when sample holders (not shown) are held in the carriages 1330a and 1330b, the sample holders can pass by each other without the sample holders colliding. For example, the second carriage 1330b can be withdrawn from the housing 1395 to cause it to move along the curved portion of the guiding elements 1320b and 1321b, to permit the first carriage 1330a to move freely along its respective guiding elements 1320a and 1321a without interfering with the second carriage 1330b. Thus, improved throughput can be achieved due to the spaced apart nature of the first and second pairs of guiding elements 1320a and 1321a and 1320b and 1321b.

Thus, this embodiment again adheres to the principle that for dual sample loading, space between the paths of the sample holders is required in at least one place (preferably under vacuum) where samples are exchanged. It will be appreciated that the three-dimensional motion in this embodiment is different from the earlier described embodiments. Sensors may be provided to cause the sample holders to stop at a loading position, and complexity at the front of the housing 1395 may be increased due to the different spatial requirements.

Again, many variations to this embodiment will be apparent to the skilled reader. For instance, in this embodiment, the sample exchange area could be moved from being in the front of the front housing to being behind the X-ray tube. Moreover, more than two carriages 1330a and 1330b could be provided, and/or both carriages 1330a and 1330b could follow curved paths. Additionally, the sample holders and the corresponding openings in the carriages need not be cylindrical and could take any shape.

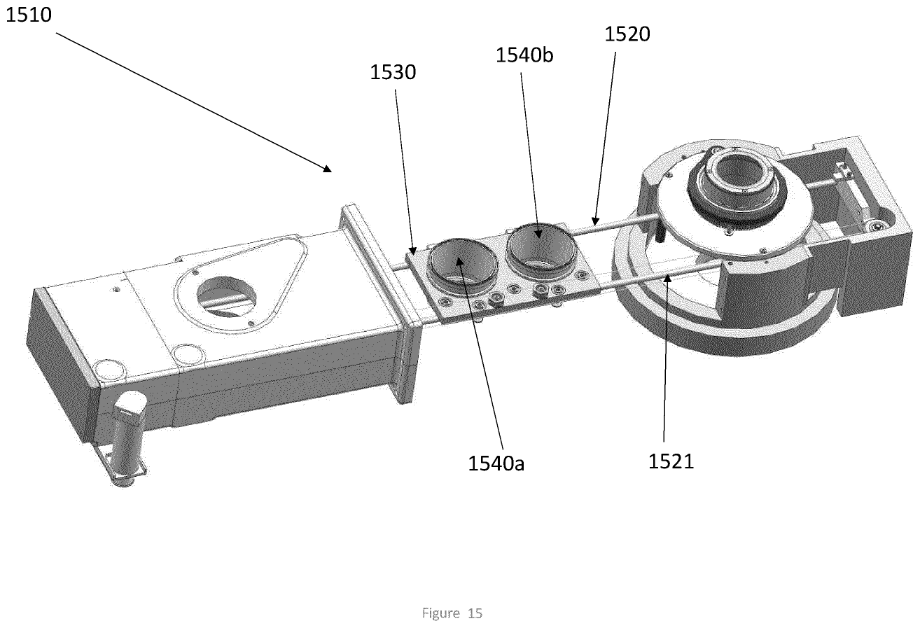

Turning next to FIG. 15, there is shown an apparatus 1510 according to a sixth embodiment. This embodiment comprises guiding elements 1520 and 1521 that are substantially similar to those of FIG. 3. However, the carriage 1530 of the sixth embodiment differs from the embodiments described above, in that it is configured to hold two sample holders 1540a and 1540b, rather than one sample holder.

In this case, a single horizontal guiding mechanism comprising the guiding elements 1520 and 1521 is provided, together with a double carriage 1530. Additional space may be provided in front of the loading position and behind the analysis position to allow both sample holders 1540a and 1540b to be positioned under the loading/analysis positions of an instrument. Because an analysis lift can be used to lift the sample under the X-ray tube and should not block the carriage, a clamping mechanism (not shown) may be provided for holding the sample in position to allow an analysis lift to go down providing a free path to the carriage 1530. In other words, since there is only one carriage 1530 in this embodiment, if one of the sample holders were lifted up by the analysis lift and kept there during the analysis, the lift would be passing through the carriage 1530 and thus preventing the carriage 1530 from returning to the loading position (i.e. the other end of the path) to load the next sample. Therefore, when the sample holder is lifted up for analysis, it can be clamped there under the X-ray tube so that the analysis lift can retract and allow the carriage 1530 to move back to the loading position. Thus, good throughout can be achieved.

In this embodiment, the guide assembly may be considered as comprising the guiding elements 1520 and 1521 and the double carriage 1530. In this case, the sample holders 1540a and 1540b traverse paths through space that are the same for a substantial portion (e.g. at least half) of their lengths, but the configuration of the guide assembly is such that the first and second sample holders 1540a and 1540b are always spaced apart as they move along their respective paths. It is to be noted that the paths do not overlap at all at the two ends thereof. Improved throughput is again achieved when compared with the apparatus 110 of FIG. 3.

As described previously, the guiding elements 1520 and 1521 and sample holders 1540a and 1540b can take any shape. Moreover, three or more sample holders could be provided on a single carriage 1530.

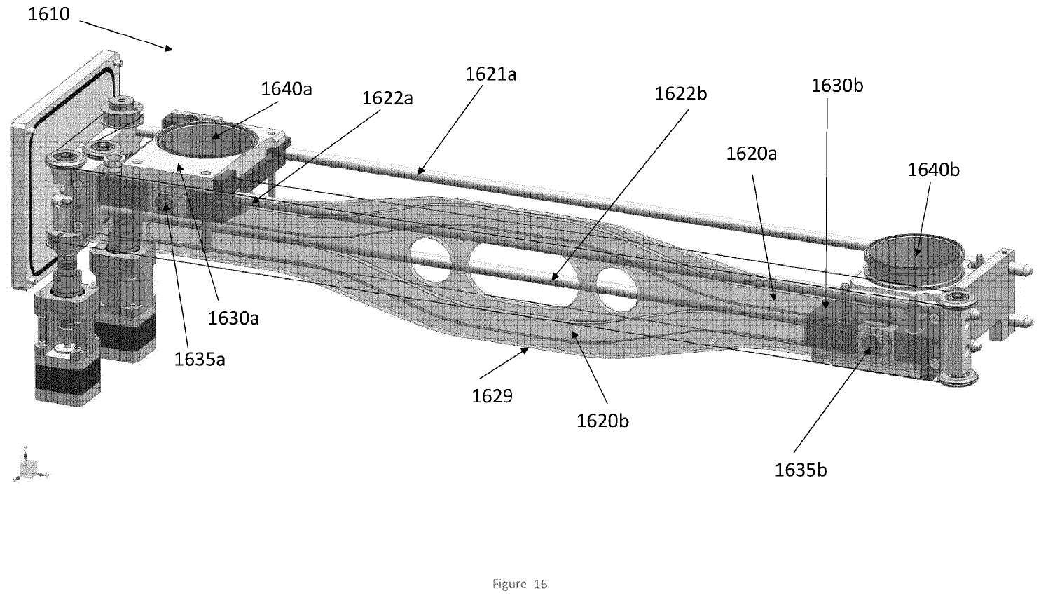

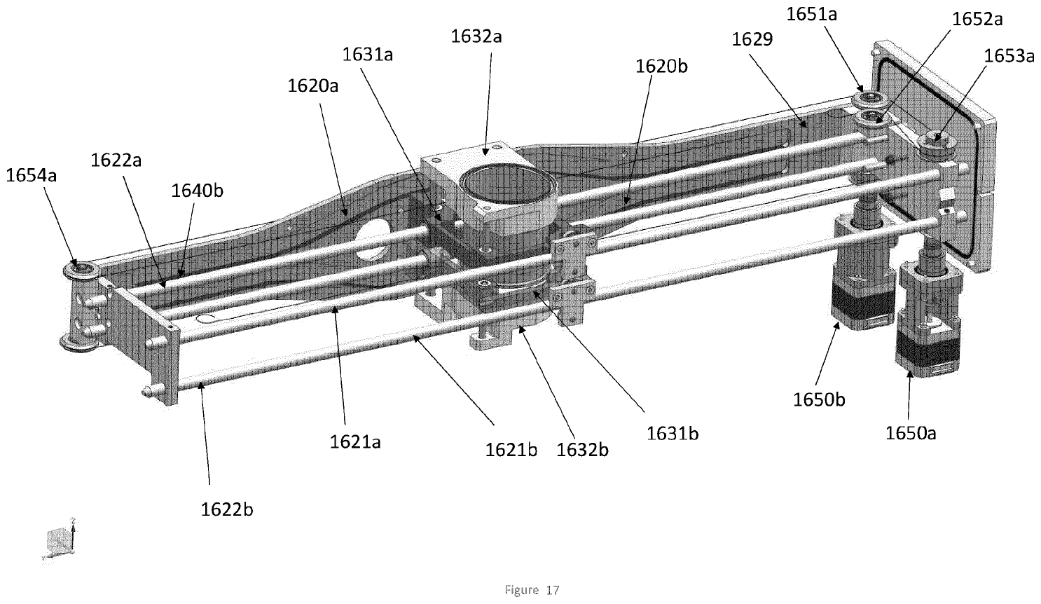

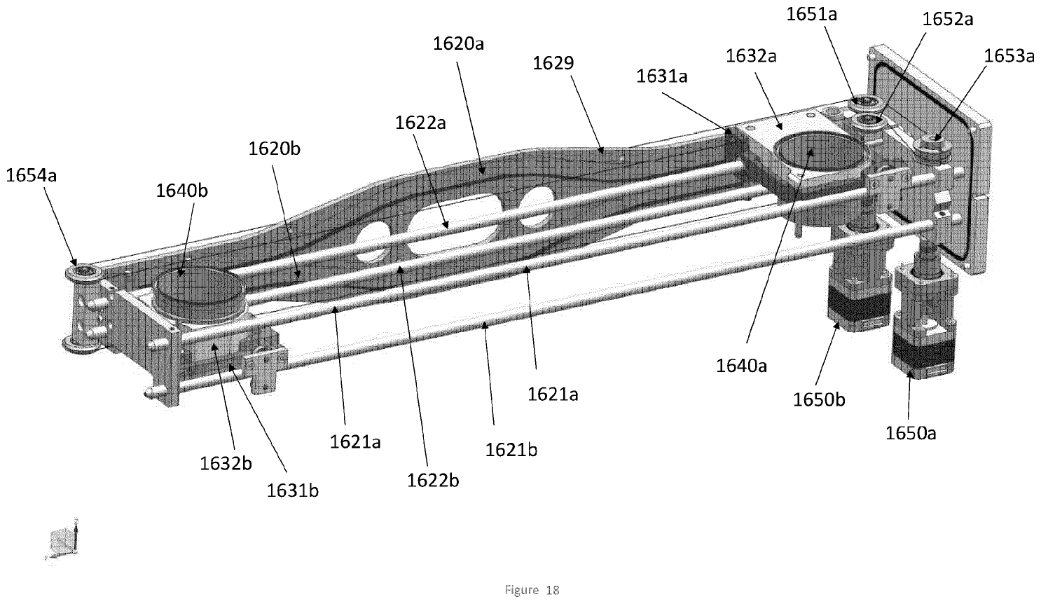

Turning next to FIGS. 16, 17 and 18, there is shown an apparatus 1610 for moving first and second sample holders 1640a and 1640b according to a seventh embodiment. The apparatus 1610 is similar to the apparatus 710 of the fourth embodiment shown in FIG. 7. In particular, FIG. 16 shows the apparatus 1610 from a similar perspective to FIG. 7 and FIG. 17 shows the apparatus 1610 from a similar perspective to FIG. 8. Due to the similarities between the apparatus 1610 and the apparatus 710, a detailed description of all components of the apparatus 1610 of the seventh embodiment is omitted for brevity.

The apparatus 1610 comprises a similar guide assembly to the fourth embodiment, comprising a flat surface 1629 that defines guiding elements 1620a and 1620b. These guiding elements 1620a and 1620b guide a first carriage 1630a and a second carriage 1630b along their paths between starting and end positions at each end of the guiding elements 1620a and 1620b and so act to provide longitudinal guiding. Pairs of longitudinal guiding elements 1621a and 1622a and 1621b and 1622b are also provided. This works in a similar way in which the corresponding elements 729, 720a, 720b of the fourth embodiment guide the carriages 730a and 730b of the fourth embodiment.

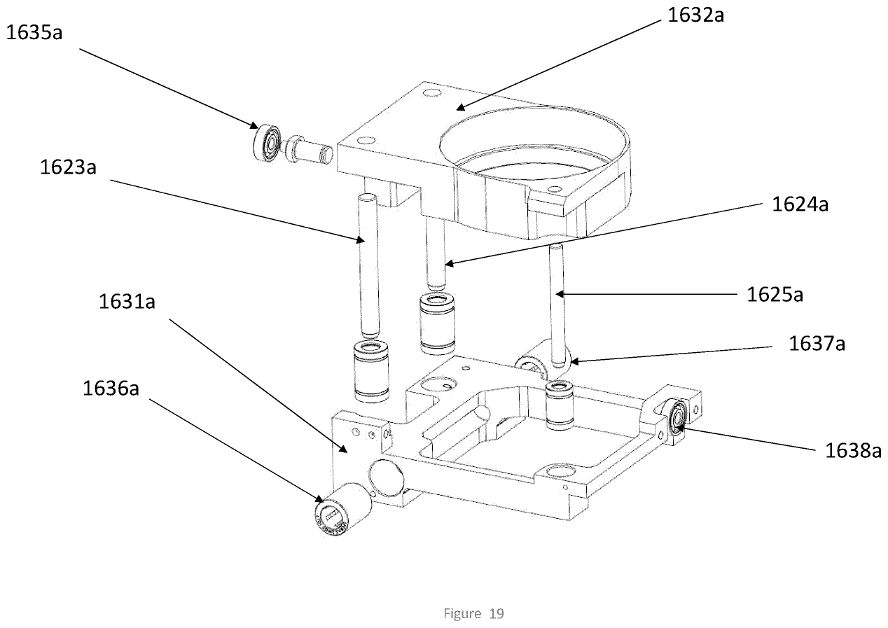

As in the fourth embodiment, the carriages 1630a and 1630b comprise distinct portions: fixed portions 1631a and 1631b; and laterally-guided portions 1632a and 1632b. These carriages 1630a and 1630b are configured to hold sample holders 1640a and 1640b. Motion of the carriages 1630a and 1630b is effected by an arrangement of motors 1650a and 1650b and pulleys 1651a, 1652a, 1653a and 1654a. Again, one or more motors may be used and each carriage may have an associated motor and pulley arrangement. As shown in FIG. 19, the fixed portion 1631a may comprise two linear ball bearings 1636a and 1637a for engaging the longitudinal guiding element 1622a. The opposite side of the fixed portion 1631a comprises a bearing 1638a that, in use, rests on top of the other longitudinal guiding element 1621a. The other fixed portion 1631b may comprise similar ball bearings. It will be appreciated that other ways of securing the fixed portions 1631a and 1631b to the guiding elements could be used.

A difference between the seventh embodiment and the fourth embodiment is the way in which the carriages 1630a and 1630b are guided. In the fourth embodiment, the protrusions 735a and 735b are shown as being guiding pins. In the fourth embodiment, bearings are hidden inside the laterally-guided portions 732a and 732b of the carriages 730a and 730b. In contrast, in the seventh embodiment, the protrusions 1635a and 1635b are pins surrounded by bearings (e.g. a pin passing through the centre of a roller bearing), with the bearings moving within the grooves of the guiding elements 1620a and 1620b. This is best shown in FIG. 16. In the generalised language used previously, at least (and optionally both) carriage may comprise a protrusion configured to engage a complementary channel of the guide assembly, and such a protrusion (or protrusions) may comprise a guiding pin and/or bearings (e.g. bearings surrounding a guiding pin). The use of bearings provides smoother motion and can reduce mechanical wear.

A further difference between the seventh embodiment and the fourth embodiment is that in the seventh embodiment, the width of guiding elements 1620a and 1620b of the flat surface 1629 is increased. Having bearings 1635a and 1635b that engage relatively wide guiding elements 1620a and 1620b can increase stability.

Moreover, in the seventh embodiment, the guiding elements 1620a and 1620b are defined by a groove in the flat surface 1629 that does not pass all of the way though the flat surface 1629. This can improve stiffness of the surface 1629, improving the reliability of the guide assembly. Thus, in the generalised language used previously, the complementary channel of the guide assembly may comprise an elongate groove in a surface of the guide assembly.

Turning next to FIG. 19, there is shown an exploded version of the carriage 1630a of FIGS. 16 to 18. The other carriage 1630b is not shown but works in a similar way. FIG. 19 is similar to the exploded view shown in FIG. 10. The carriage 1630a comprises a fixed portion 1631a and a laterally-guided portion 1632a. The fixed portion 1631a comprises a protrusion 1635a for engaging the guiding element 1620a. In the seventh embodiment, three lateral guiding elements 1623a, 1624a and 1625a are provided, instead of the two lateral guiding elements 723a and 724a of the fourth embodiment. The lateral guiding elements 1623a, 1624a and 1625a are lateral guiding rods. Because of the additional lateral guiding element 1625a, the shape of the carriage 1630a (and also the carriage 1630b) is changed. This arrangement with three lateral guiding elements leads to improved stability.

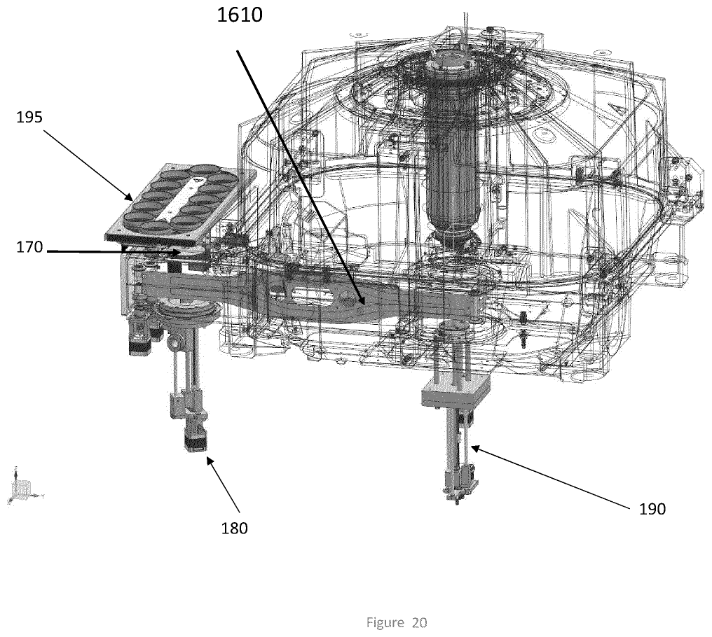

FIG. 20 shows the apparatus 1610 of the seventh embodiment in situ, in the same system as FIG. 1. As described previously, the system comprises a shutter 170, a sample lift 180, an analysis lift 190 and a sample changer 195. It can be seen that due to its compact shape, the apparatus 1610 can be fitted to an existing system and can improve the throughput of the system without requiring significant modifications to accommodate the apparatus 1610.

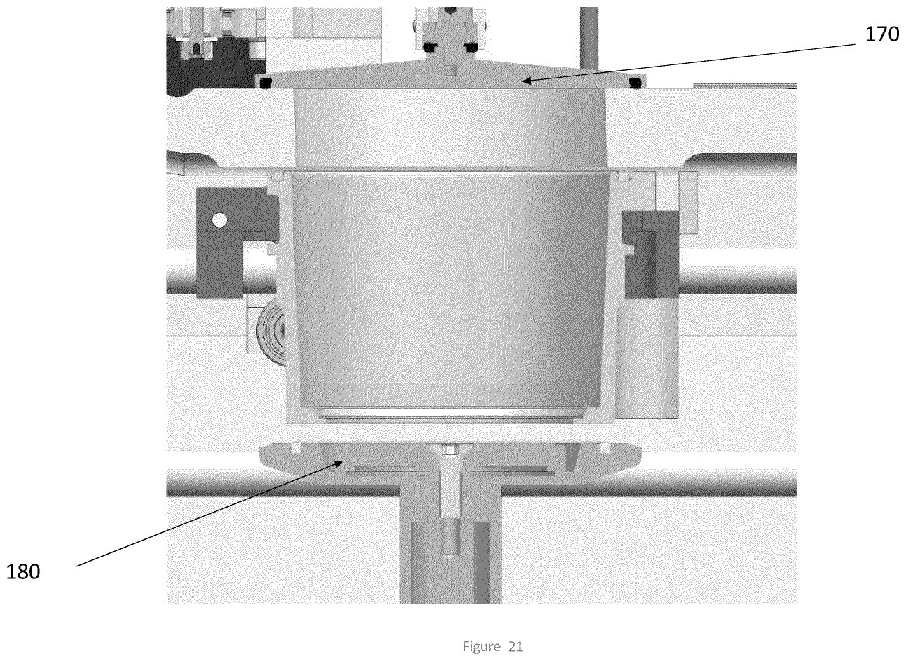

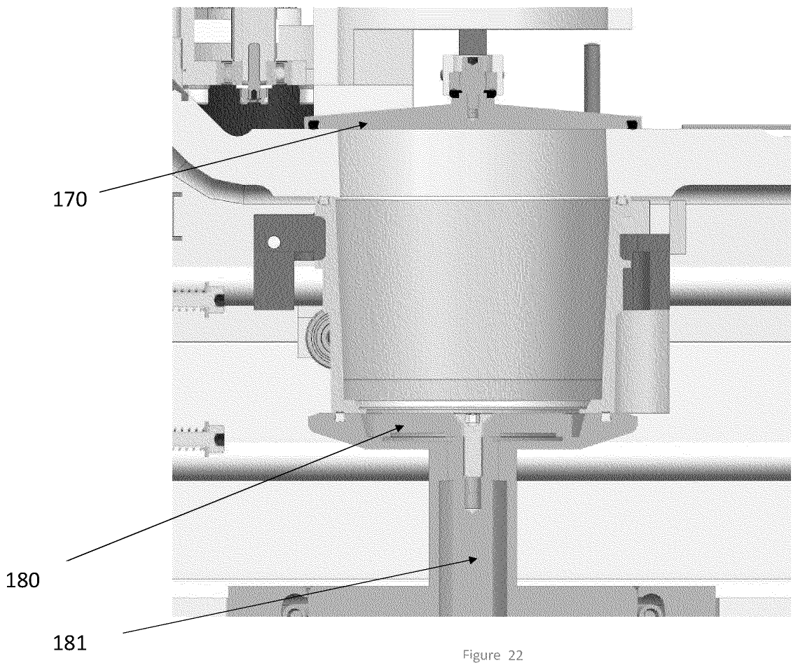

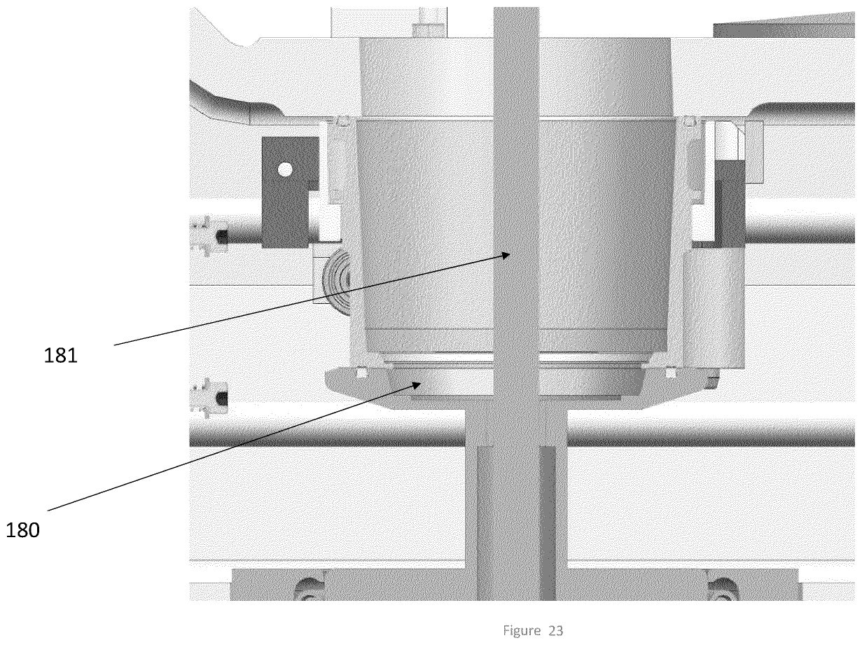

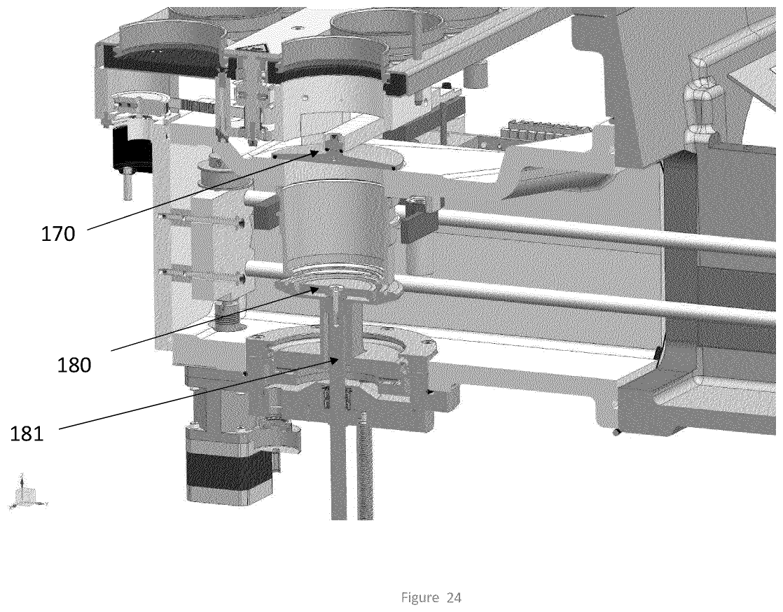

FIGS. 21 to 24 show how the apparatus 1610 can form an effective vacuum in existing systems, such as the systems of FIGS. 1, 12 and 20. FIG. 21 shows an unsealed state, FIGS. 22 and 23 show a sealed state and FIG. 24 shows a cross-sectional view. In the existing design of an ARL 9900, a system sample holder is used as a part of a transitional chamber. When a sample holder is approaching the loading position, there has to be clearance above and below, as shown in FIG. 21. When new sample is introduced, the transitional chamber is first closed, as shown in FIG. 22. To do this, the lift 180 moves up to push the sample holder into abutment to form a vacuum. When unloading a sample, after vacuum breaking occurs, the lid of the shutter 170 is moved away and a rod 181 moves up to push the sample out of its sample holder, to allow changing of the sample, as shown in FIG. 23. The apparatus 1610 of the seventh embodiment is well-suited for use in this system, because sample holders in both of the carriages 1630a and 1630b have starting positions that are in essentially the same place, which means that the vacuum-forming procedure works for sample holders carried by either carriage. The second to sixth embodiments can also be used with a similar vacuum-forming system, because they can each be configured so that multiple sample holders have the same starting position.

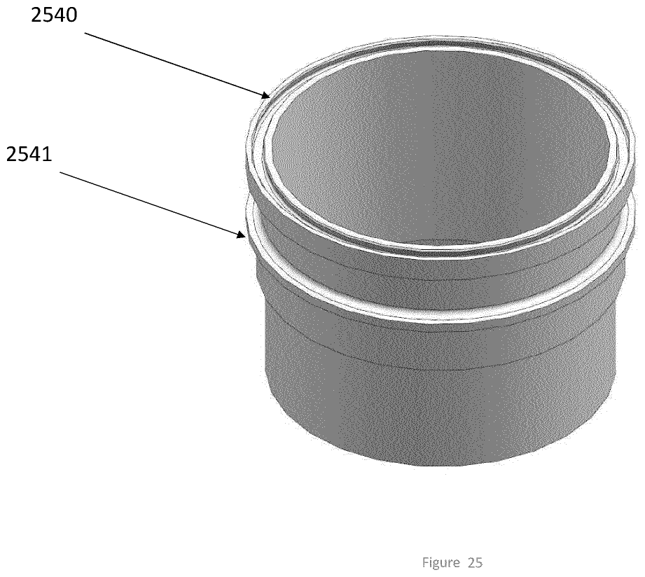

In FIG. 25, there is shown a sample holder 2540 for use in any of the apparatus described herein. The sample holder 2540 is a generally cylindrical vessel with a base and upstanding sidewalls, for containing a sample. The exterior surface of the sample holder 2540 comprises a protrusion or ridge 2541 for retaining the sample holder 2540 within an opening of a carriage. Of course, other shapes can be used, provided that the carriages are adapted accordingly.

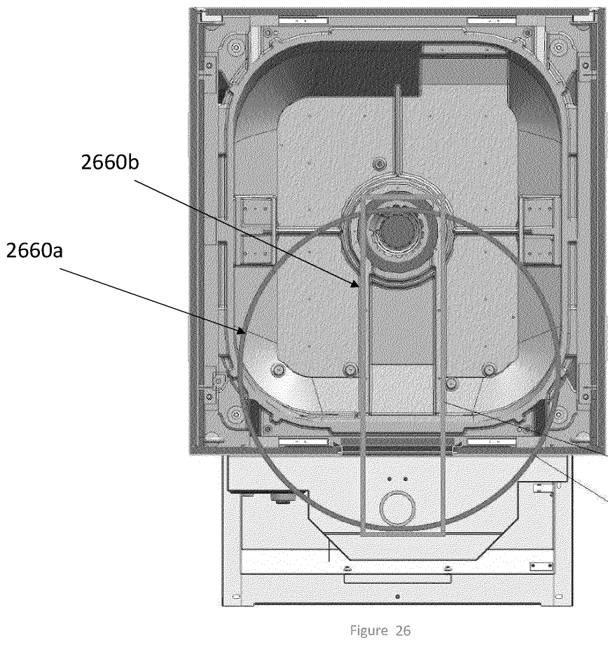

Turning next to FIG. 26, there is shown a comparison of the spatial requirements of a linear or translational transfer assembly 2660b (such as any of those described herein) against the spatial requirements of a rotational transfer assembly 2660a. Rotational loading mechanisms take up more space than the apparatus described herein, because samples follow a long, circular path. In contrast, guiding sample holders back and forth along independent paths that deviate from each another for at least a portion of the lengths of the paths allows the sample holders to be prevented from colliding without taking up as much space as rotational mechanisms. It will thus be appreciated that the arrangements described herein provide guide assemblies configured to cause the sample holders to undergo curvilinear or rectilinear translational motion (rather than rotational motion) along their respective paths. The area of a circle increases with the square of its radius. Thus, the space savings that arise due to the use of the linear transfer assemblies described herein are particularly pronounced when sample holders are to be moved between positions that are far apart.

It will be understood that many variations may be made to the above apparatus, systems and methods whilst retaining the advantages noted previously. For example, where specific components have been described, alternative components can be provided that provide the same or similar functionality.

The above embodiments relate to apparatus in which only two sample holders are shown, for ease of illustration. It will be appreciated that any number of sample holders can be provided using the principles described above.

Moreover, the above embodiments omit a detailed discussion of the components within analytical instruments. It will be appreciated that various combinations of lifts, monochromators, goniometers and the like can be combine with the apparatus described above.

While cylindrical sample holders have been referred to extensively above, other shaped sample holders can be moved using the apparatus described herein. The sample holders and carriages described herein are replaceable and can take various forms.

Moreover, the above apparatus do not depict vacuum chambers in detail for ease of illustration, but it will be appreciated that the described embodiments are particularly suited to systems where samples need to be treated under vacuum conditions and/or where multiple samples are to be analysed. For instance, electron microscopy instruments can also make use of the apparatus described herein.

The sample holders described herein can be attached to guiding elements via various means. For example, in some embodiments described herein, such as those shown in FIGS. 7 to 12 and 16 to 20, guiding elements pass through carriages. However, in such cases, a plurality of wheels (e.g. a clamping wheel assembly similar to a roller-coaster wheel assembly comprising at least one, two or three of: underfriction, or up-stop, wheels; tractor, or running, wheels; and side friction wheels) could instead be used to attach carriages to their respective guiding elements. Similarly, where wheel arrangements are illustrated, guiding elements could instead pass through openings in the carriages.

Each feature disclosed in this specification, unless stated otherwise, may be replaced by alternative features serving the same, equivalent or similar purpose. Thus, unless stated otherwise, each feature disclosed is one example only of a generic series of equivalent or similar features.

As used herein, including in the claims, unless the context indicates otherwise, singular forms of the terms herein are to be construed as including the plural form and, where the context allows, vice versa. For instance, unless the context indicates otherwise, a singular reference herein including in the claims, such as “a” or “an” (such as a sample holder or a carriage) means “one or more” (for instance, one or more sample holders, or one or more carriages). Throughout the description and claims of this disclosure, the words “comprise”, “including”, “having” and “contain” and variations of the words, for example “comprising” and “comprises” or similar, mean that the described feature includes the additional features that follow, and are not intended to (and do not) exclude the presence of other components.

The use of any and all examples, or exemplary language (“for instance”, “such as”, “for example” and like language) provided herein, is intended merely to better illustrate the disclosure and does not indicate a limitation on the scope of the disclosure unless otherwise claimed. No language in the specification should be construed as indicating any non-claimed element as essential to the practice of the disclosure.

Any steps described in this specification may be performed in any order or simultaneously unless stated or the context requires otherwise. Moreover, where a step is described as being performed after a step, this does not preclude intervening steps being performed.

All of the aspects and/or features disclosed in this specification may be combined in any combination, except combinations where at least some of such features and/or steps are mutually exclusive. In particular, the preferred features of the disclosure are applicable to all aspects and embodiments of the disclosure and may be used in any combination. Likewise, features described in non-essential combinations may be used separately (not in combination).

A method of manufacturing and/or operating any of the apparatus disclosed herein is also provided. The method may comprise steps of providing each of the disclosed features disclosed and/or configuring or using the respective feature for its stated function.

1. An apparatus for moving first and second sample holders between respective first and second starting positions and respective first and second end positions, comprising a guide assembly configured to:
guide the first sample holder along a first path from the first starting position to the first end position and back along the first path from the first end position to the first starting position; and
guide the second sample holder along a second path from the first starting position to the second end position and back along the second path from the second end position to the second starting position;
wherein the guide assembly is configured such that the first and second sample holders are spaced apart as they move along at least a portion of the lengths of their respective paths.

2. The apparatus claim 1, wherein the paths are parallel at or near: the first and second starting positions; and/or the first and second end positions.

3. The apparatus of claim 1, wherein: the starting positions of each of the sample holders are the same; and/or the end positions of each of the sample holders are the same.

4. The apparatus of claim 1, wherein:
the first and/or second starting position is a sample loading position; and/or
the first and/or second end position is a sample analysis position or a sample unloading position.

5. The apparatus of claim 1, wherein the guide assembly is configured such that the paths are spaced apart in a direction that is substantially perpendicular to the paths.

6. The apparatus of claim 1, wherein the guide assembly is configured such that separation between the paths varies along the lengths of the paths.

7. The apparatus of claim 1, wherein the guide assembly is configured such that the paths are spaced apart for: only a portion of their lengths; or all of their lengths.

8. The apparatus of claim 1, wherein the guide assembly is configured such that the first and second paths are spaced apart along at least a portion of their lengths, to permit the sample holders simultaneously to move in opposite directions along their respective paths.

9. The apparatus of claim 1, wherein the guide assembly is configured such that a distance between the paths is greater at or near a centre of the paths than at: one end of the paths; or at both ends of the paths.

10. The apparatus of claim 1, wherein the guide assembly is configured such that at least one and preferably each of the paths comprise:
a curved portion; and/or
a substantially straight portion.

11. The apparatus of claim 1, wherein the guide assembly comprises one or a plurality of longitudinal guiding elements configured to guide the sample holders longitudinally along their respective paths.

12. The apparatus of claim 1, wherein the guide assembly comprises one or a plurality of lateral guiding elements configured to: guide the sample holders laterally as they move along their respective paths; and/or vary a separation between the paths.

13. The apparatus of claim 11, wherein:
the one or a plurality of longitudinal guiding elements comprise longitudinal guiding rods; and/or
the one or a plurality of lateral guiding elements comprise lateral guiding rods.

14. The apparatus of claim 1, wherein the guide assembly comprises at least one carriage configured to move at least one sample holder along its respective path.

15. The apparatus of claim 14, wherein one or a plurality of carriages each comprise one or a plurality of lateral guiding elements.

16. The apparatus of claim 14, wherein at least one of the carriages comprises a protrusion configured to engage a complementary channel of the guide assembly, the complementary channel configured to cause the at least one carriage to move at least one of the sample holders along its respective path, preferably wherein the complementary channel acts as a lateral and/or longitudinal guiding element.

17. The apparatus of claim 16, wherein the complementary channel comprises at least one of: an elongate channel through a surface of the guide assembly, and/or an elongate groove in a surface of the guide assembly, configured to engage the at least one protrusion.

18. The apparatus of claim 16, wherein the complementary channel comprises:
a curved portion; and/or
a substantially straight portion.

19. The apparatus of claim 14, wherein at least one carriage comprises: a fixed portion that is longitudinally-guided and moves substantially in a straight line between the starting and end points; and a laterally-guided portion for holding a sample holder that moves away from the fixed portion as the carriage moves between the starting and end points.

20. The apparatus of claim 1, wherein the guide assembly comprises a first guide configured to guide the first sample holder along the first path and a second guide configured to guide the second sample holder along the second path.

21. The apparatus of claim 1, wherein the guide assembly is configured such that the first and second sample holders are held substantially flat as they move along their respective paths.

22. The apparatus of claim 1, wherein the guide assembly is configured to cause the sample holders to undergo curvilinear or rectilinear translational motion along their respective paths.

23. The apparatus of claim 1, further comprising at least one vacuum chamber, wherein any one or more of: the first starting position; the second starting position; the first end position; and the second end position are in the at least one vacuum chamber.

24. An analytical instrument comprising the apparatus of claim 1 and an analyser, wherein the apparatus is configured to move the sample holders to the analyser for analysis of samples within the sample holders.

25. The analytical instrument of claim 24, wherein the analyser comprises at least one of: a spectrometer, a diffractometer, and a microscope, configured to analyse samples using photons, electrons and/or ions.
